(19) United States
(12) Patent Application Publication
(10) Pub. No.: US 2016/0344675 A1
(43) Pub. Date: Nov. 24, 2016

(54) MEMORIAL WEBSITE, SYSTEM AND METHOD

(71) Applicants: Gregory Samaras, Whitestone, NY (US); Menelaos Tzilvelis, Flushing, NY (US)

(72) Inventors: Gregory Samaras, Whitestone, NY (US); Menelaos Tzilvelis, Flushing, NY (US)

(21) Appl. No.: 15/162,404

(22) Filed: May 23, 2016

Related U.S. Application Data
(60) Provisional application No. 62/165,016, filed on May 21, 2015.

(51) Int. Cl. H04L 12/58; H04L 29/08; H04L 29/06

(52) U.S. Cl. CPC H04L 51/32; H04L 65/1063; H04L 67/306

(57) ABSTRACT

An online social-media system for deceased individuals comprises a webserver for generating a web page. Users may log-on and create an account. Account holders may create specific page or pages with information. Users also select an administrator who will be able to access and manage the account after the original user is deceased. The system also provides features which permit continued posthumous interaction by the user with relatives, friends, and others.

### CROSS-REFERENCE TO RELATED APPLICATIONS

This application claims the benefit and priority to U.S. Provisional Application No. 62/165,016 filed May 21, 2015, and entitled “A MEMORIAL WEBSITE, SYSTEM and METHOD.”

### FIELD OF THE TECHNOLOGY

The subject matter disclosed herein generally relates to social media websites and applications. More particularly, the invention discloses a computer system and website which allows a user to maintain a continued digital presence after death.

### BACKGROUND

Social media websites and applications have increased in popularity since the dawn of the internet age. Their popularity further exploded with the ability to access the internet anytime, anywhere through handheld devices such as cellphones, tablets, iPads®, etc. Recent statistics show that approximately 75% of individuals who regularly use the internet use some form of social media, whether in the form of Facebook, Twitter, Instagram, Pinterest, LinkedIn, or some other site.

For many such users, their social media account or accounts contain their whole life—their history, their successes and failures, their family interactions, and even the mundane details of their everyday lives. Further, many social media accounts contain valuable and sentimental information in the form of pictures and videos. Additionally, as social media has become more and more prevalent, it has also become a primary means of interaction between individuals, even between family members and close friends.

Despite the prevalence and integration of social media into many users' lives, social media platforms do not currently provide a way for deceased individuals to maintain in contact with a living acquaintance or to continue interacting with them. Instead, many sites remove inactive accounts as well as accounts of deceased users. Others simply allow the account to continue unused, frozen in whatever state the now-deceased user left it. Further, the existing social media platforms do not provide a way for a user to continue to interact with acquaintances after death.

Thus, an effective and reliable social media platform or website which is specifically tailored to postmortem individuals would be well received in the art.

### BRIEF DESCRIPTION

According to one aspect of the invention, a method of gift-giving comprises: hosting, by a server, an account at least one of created and managed by an individual; accessing, by the server, a database storing information provided from a social media account of a recipient after the individual becomes deceased; analyzing, by the server, the information accessed by the server from the database; and determining, by the server after the individual becomes deceased, an appropriate gift to provide the recipient using the information accessed by the server from the database.

According to a second aspect of the invention, a system comprises: a server hosting an account that is at least one of created and managed by an individual; and a database storing information provided from a social media account of a recipient after the individual becomes deceased; wherein the server is configured to access the database after the individual becomes deceased; wherein the server is configured to analyze the information accessed by the server from the database after the individual becomes deceased; wherein the server is configured to determine, after the individual becomes deceased, an appropriate gift to provide the recipient using the information accessed by the server from the database.

According to a third aspect of the invention, a computer program product, comprising a computer readable hardware storage device storing a computer readable program code, said computer readable program code comprising an algorithm that, when executed by a server connected to a database, implements a method of gift-giving comprising: hosting, by the server, an account at least one of created and managed by an individual; accessing, by the server, the database, wherein the database stores information provided from a social media account of a recipient after the individual becomes deceased; analyzing, by the server, the information accessed by the server from the database; and determining, by the server after the individual becomes deceased, an appropriate gift to provide the recipient using the information accessed by the server from the database.

### BRIEF DESCRIPTION OF THE DRAWINGS

The subject matter which is regarded as the invention is particularly pointed out and distinctly claimed in the claims included at the conclusion of this specification. The foregoing and other features and advantages of the invention are apparent from the following detailed description taken in conjunction with the accompanying drawings in which:

FIG. 1 depicts a schematic view of an embodiment of a memorial website system in accordance with one embodiment;

FIG. 2 depicts a flowchart of an embodiment of the creation of a funeral services page in accordance with one embodiment;

FIG. 3 depicts a schematic view of the funeral services page of FIG. 2 in accordance with one embodiment;

FIG. 4 depicts a schematic view of the funeral services page of FIGS. 2-3 in accordance with one embodiment;

FIG. 5 depicts a schematic view of a memorial profile in accordance with one embodiment;

FIG. 6 depicts a flowchart of a user option for the memorial profile of FIG. 5 in accordance with one embodiment;

FIG. 7 depicts a flowchart of another user option for the memorial profile of FIG. 5 in accordance with one embodiment;

FIG. 8 depicts another schematic view of the memorial profile of FIG. 5 in accordance with one embodiment;

FIG. 9 depicts a flowchart of a method performed by the memorial website system of FIG. 1 in accordance with one embodiment;

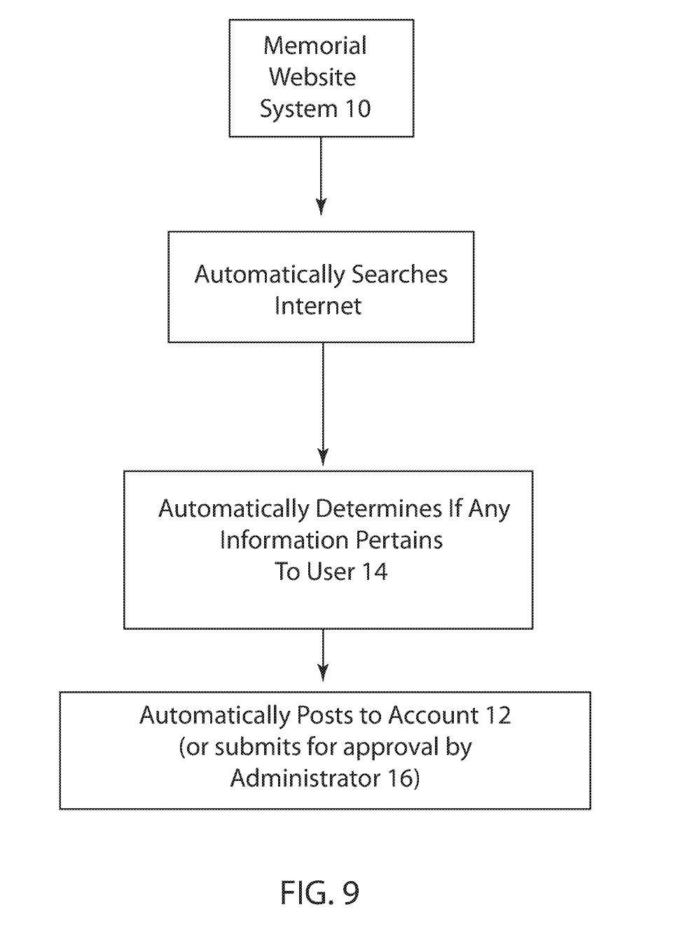

FIG. 10 depicts a flowchart of a virtual vending feature of the memorial website system of FIG. 1 in accordance with one embodiment;

FIG. 11 depicts a flowchart for virtual vending in accordance with one embodiment;

FIG. 12 depicts a flowchart for a predetermined interactive message in accordance with one embodiment;

FIG. 13 depicts a flowchart for a contingent interactive message in accordance with one embodiment;

FIG. 14 depicts a flowchart for a responsive interactive message in accordance with one embodiment;

FIG. 15 depicts another flowchart for a responsive interactive message in accordance with another embodiment;

FIG. 16 depicts a flowchart for a predetermined interactive gift in accordance with one embodiment;

FIG. 17 depicts a flowchart for a contingent interactive gift in accordance with one embodiment;

FIG. 18 depicts a flowchart for responsive interactive gift in accordance with one embodiment;

FIG. 19 depicts another flowchart for a responsive interactive gift in accordance with one embodiment;

FIG. 20 depicts a computer system of the memorial website system in accordance with one embodiment; and

FIG. 21 depicts a schematic view of a memorial website system in accordance with one embodiment.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the devices thereof, the relative arrangement thereof, etc; these are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

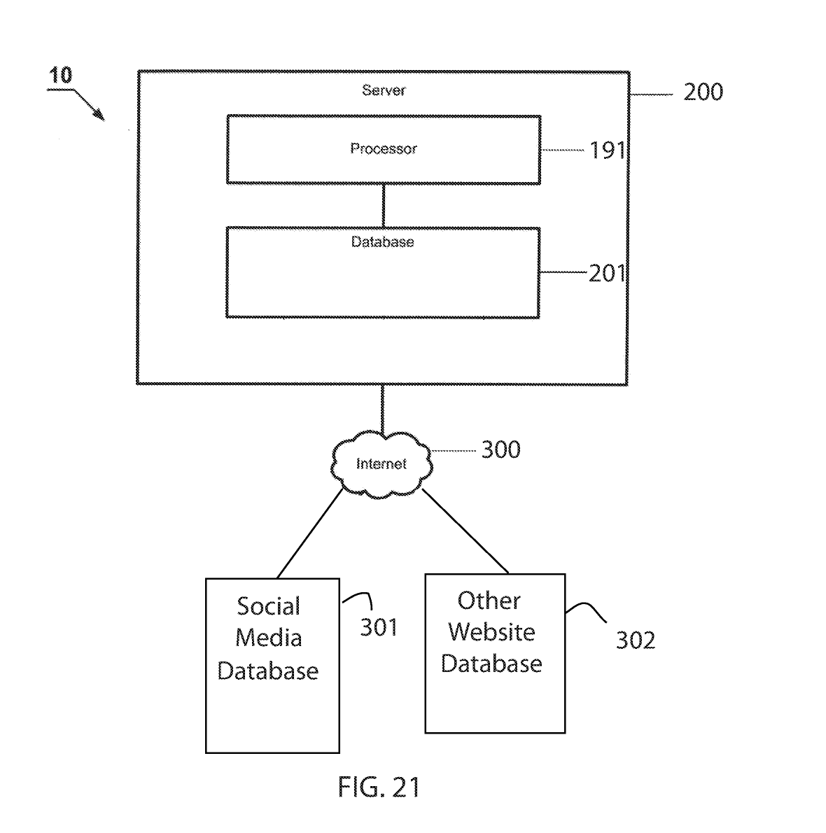

As shown in FIG. 21, in one embodiment, the memorial website system 10 may include a server 200. It should be understood that the server 200 shown in FIG. 21 may be one or more servers and that hereinafter the term “server” means at least one server. For example, the methods and capabilities described herein may be hosted, processed, ran, or otherwise performed by one or a plurality of connected servers. The server 200 may include a database 201 or other file storage location or memory device. The database 201 may be one or more databases, and may include a plurality of connected databases for storing information and data in the memorial website system 10. Hereinafter “database” means at least one database. Still further, the server 200 may include a processor 191 coupled or otherwise connected to the database 201. The processor 191 may be one or more computer processors capable of processing data and performing the analyses, methods, and capabilities described herein and hereinafter, “the processor” means at least one processor. In one embodiment, the server 200 may be connected to the internet 300. Through this connection to the internet, the server 200 may also connect to various social media sites. It should be understood that the social media sites may include their own individual databases 301 or other website databases 302. It will be understood that information from the internet 300 and from social media site databases 301 and other website databases 302 would be able to be retrieved by the server 200.

In one embodiment, a memorial website system 10 includes an account 12 for a user 14 hosted on the server 200. The user 14 may create and manage the account 12 on the memorial website system 10 while the user 14 is alive. Information relating to the user's account may be stored by the memorial website system, for example on the database 201. Further, the user 14 may appoint another individual to be an administrator 16 of their account 12. The administrator 16 may be allowed to control the user's account 12 after the user 14 has deceased. The user 14 may provide instructions and access to the administrator 16 at any time before death. Alternatively, the user 14 may designate the administrator 16 before death, but may decide not to inform the administrator 16 of the designation or to provide access to the user's account 12. In this embodiment, the memorial website system 10 may be instructed that, upon or after the user's death, the memorial website system 10 is to automatically provide the administrator 16 with a notification and pertinent information such as passwords, other log in information, etc. The memorial website system 10 may accomplish this notification by email, text message, through the memorial website system 10 itself (if the administrator 16 has their own account), other social media systems, regular mail, telephone communications, or any other means of communication. Thus, in at least some embodiments, an administrator 16 may have no advance knowledge of their future status as administrator 16 or that the user 14 has created an account 12. This may be preferred by users who do not wish others to know that they are creating an account 12, or are contemplating their demise.

In one embodiment, the user 12 may require that the memorial website system 10 receive confirmation that the user 14 has deceased before the memorial website system 10 allows the administrator 16 to control the account 12 or before the memorial website system 10 takes some other action or allows some other action to be taken. In a further embodiment, confirmation of the user's death may require a death certificate or some other official documentation. In another embodiment, the account 12 may be linked with a funeral home 18. In this embodiment, the funeral home 18 may have an employee who is authorized to confirm the user's death, such as the funeral home director. The funeral home director may be charged with passing on the account information to the administrator 16, with selecting the administrator 16, or with acting as the administrator 16, whether temporarily or permanently.

In an additional embodiment, the memorial website system 10 may be able to search a government database 19 (accessed through the internet 300 or through another connection means). The user 12 may require the issuance of a death certificate or other official documentation in or from the government database 19 before an action may be taken. The memorial website system 10 may also be directly connected to the government database 19 such that it would immediately receive this documentation or notification of its issuance. Alternative methods of receiving notice of, or confirming and verifying the user's death may also be utilized.

Alternatively, the user 14 may allow the administrator 16 to access or control the account 12 before the user's death. This will remove the need for independent confirmation of the user's death, and prevent any risk that the administrator 16 is not able to access the account 12 after the user's death. In some embodiments, the administrator's access or control may be limited before the user's death. Limitations may include, having access or control over only a part of the account 12, having access but no control over the account 12, requiring the user 14 to confirm any action taken by the administrator 16, etc. For example, an administrator 16 may have the ability to upload photos to the account 12, but may be restricted from posting text or changing biographical information. In another example, the administrator may be able to change the user's biographical information such as date of birth or hometown, while not being able to change the user's other preferences, such as the types of music the user likes, the books they like to read, or their favorite sports teams. In a still further example, the administrator 16 may be able to upload photos or text, or may change biographical information; however, these changes will not be immediately seen by anyone other than the user 14. The user 14 may then be presented with the option of accepting the uploaded information and making it a part of the account 12 or rejecting the changes. The user 14 may thus be able to preview information before it is available to be seen on the account 12. Multiple combinations of aspects that the administrator 16 may be given control of or restricted from will be easily contemplated by one having skill in the art.

In a further embodiment, the user 14 may appoint multiple administrators 16 for an account 12. Administrators 16 may have equal authority and control over the account 12 or certain administrators 16 may have more authority than other administrators 16. In one embodiment with multiple administrators 16, the user 14 may select one primary administrator 16a (not depicted). The primary administrator 16a may be given the option of allowing other secondary administrators 16b (not depicted) to have authority or may choose to require confirmation of the secondary administrators' 16b actions. Secondary administrators 16b may have been chosen by the user 12 or may be chosen by the primary administrator 16a. The primary administrator 16a may also have the ability to select what features the secondary administrator(s) 16b may control. For example, the primary administrator 16a may give the secondary administrators 16b control over uploading pictures to the account 12, but the secondary administrator 16b may have no other powers. Alternatively, the user 14 may divide the administrators' authority to cover different features of the memorial website system 10. For example, the user 14 may select a first administrator to have control over pictures associated with the account 12, while a second administrator has control over text posted on the account. In a further example, the first and second administrators in the previous example may be secondary administrators 16b, and there may be a third administrator who is a primary administrator 16a and has control over both of these features. Multiple combinations of primary administrators and secondary administrators may be used. Similarly multiple combinations of elements that the plurality of administrators 16 may be given control of or restricted from will be easily contemplated by one having skill in the art.

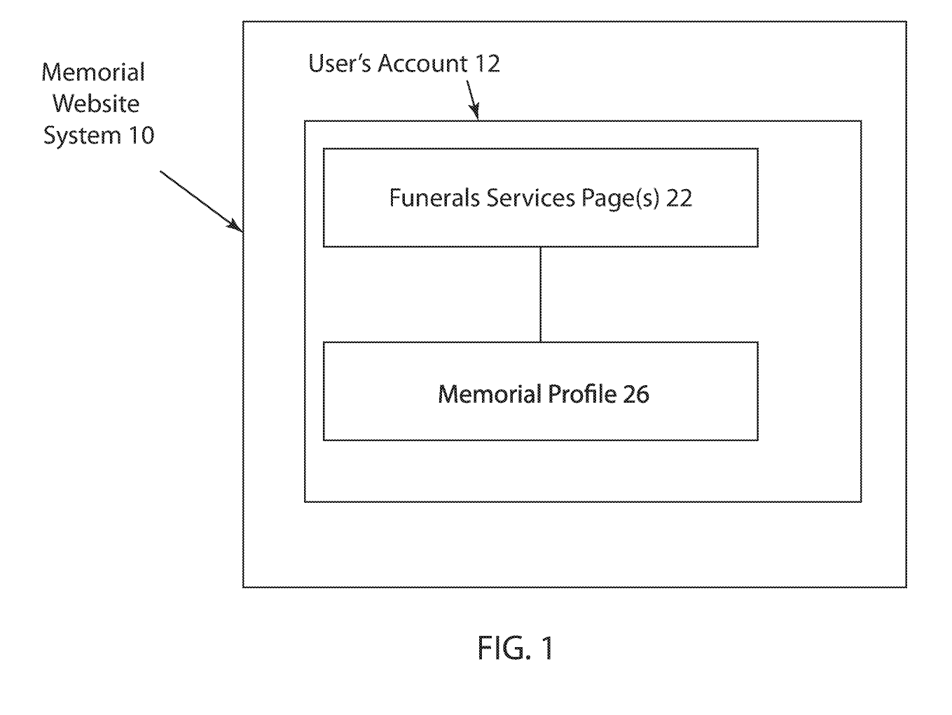

In one embodiment shown in FIG. 1, a user's account 12 on the memorial website system 10 may be comprised of a funeral services page (or pages) 22 and a memorial profile or memorial page (or pages) 26. It should be understood that the funeral services page(s) 22 and the memorial profile 26 may each be comprised of a plurality of pages. In one embodiment, the plurality of pages may all be accessible through a home page. Other embodiments may include additional features or pages. In an additional embodiment, the funeral services page(s) 22 may be comprised of a public funeral services page 23 and a non-public funeral services page 24, and/or the memorial profile 26 may be comprised of a public memorial profile 27 and a non-public memorial profile 28. A public funeral services page 23 and a public memorial profile 27 may mean a page that any individual can navigate to and view its contents, whether by searching the internet, logging into the memorial website system 10 and browsing to the specific page, or by some other means of access. A non-public funeral services page 24 and a non-public memorial profile 28 may mean a page that is only available to a limited number of individuals, such as favorites in a contact list on the user's phone or email account. Access to a non-public page or profile may be controlled by a variety of means which are well understood in the art.

As discussed above, the user 14 may have selected different administrators 16 for the distinct features of the memorial website system 10, may have given each administrator 16 authority over all parts of the account 12, or may have given a primary administrator 16a the ability to select and oversee other secondary administrators 16b. For example, a secondary administrator 16b may have control over only biographical data on the account 12, and their control may be subject to review by a primary administrator 16a.

While many elements of this description may be discussed with primary reference to one of the funeral services page(s) 22 and the memorial profile 26, these features of the memorial website system 10 will interact and may together make up the user's account 12. Thus, any and all elements discussed which reference one or the other of the funeral services page(s) 22 and the memorial profile 26 may also be applicable to the other as well. It should be understood that the elements discussed in this description are meant to apply to the memorial website system 10 as a whole.

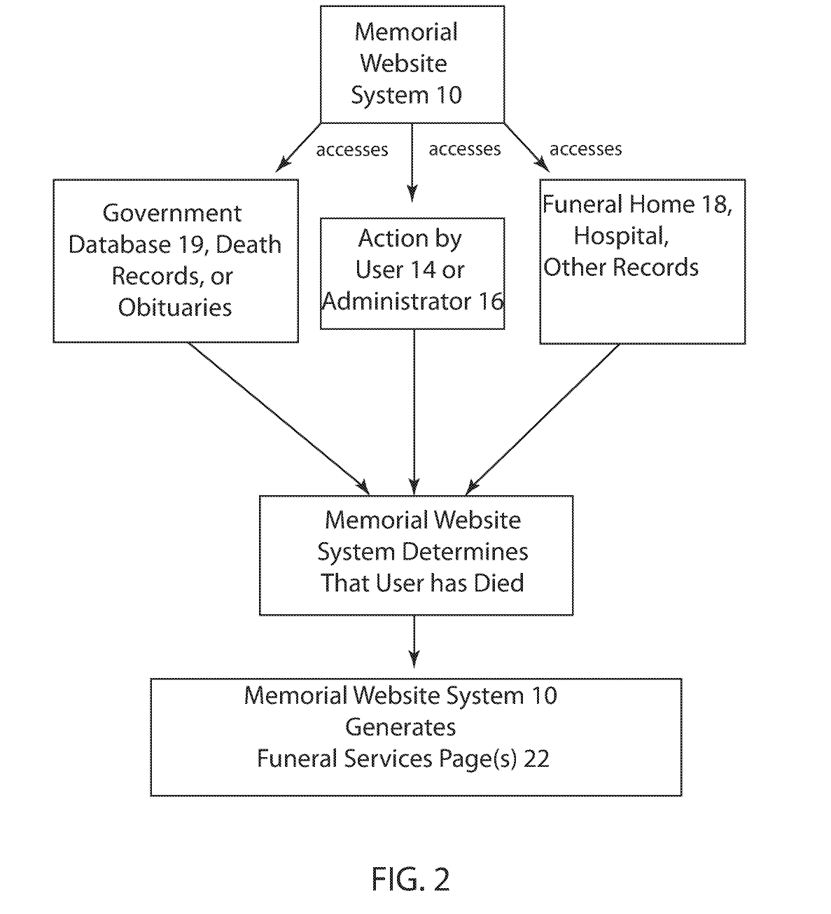

Turning now to FIG. 2, there is depicted a flowchart depicting an embodiment of the creation of a funeral services page.

The funeral services page(s) 22 (or memorial profile 26 as is discussed further below) may be displayed automatically upon the user's death. This may be accomplished by the memorial website system 10 automatically checking a government database 19 for death records or death certificates; automatically checking newspapers and other obituaries; automatically receiving notification of death from some other source; or by an action taken by a funeral home 18, hospital, morgue or some other service. The information included on the funeral services page(s) 22 may be generated automatically based on information acquired by the memorial website system 10, or may be generated based on actions taken by the user 14, the administrator 16, or a third party.

For example, in one embodiment, memorial website system 10 may determine that the user 14 is now deceased. The memorial website system 10 may then create a funeral services page(s) 22 for the user 14. In one embodiment this page may simply provide information that the user 14 has deceased. For example, the funeral services page(s) 22 may include the user's name and the date of death.

In some cases, a funeral services page(s) 22 may be created even where the deceased has not created an account 12 on the memorial website system 10. The system 10 may create the funeral services page(s) 22 as a public service in order to provide information. For example, in another embodiment, the page may be accessed and/or controlled by a relative or next of kin after validation steps are taken, such as documentation of the status as next of kin; verification by the estate, funeral director, or other individual; or other means of demonstrating that access should be granted. At this time, the person granted access may take over the account 12 as an administrator 16.

In one embodiment, the funeral services page(s) 22 may include some information that was previously posted by the user 14, such as a pre-written obituary, a parting message, or simply a short goodbye. The user 14 may have also generated information to be posted, such as a list of family surviving the user 14, The funeral services page(s) 22 may become visible to the public automatically based on the occurrence of one of the actions described above, or may require an action by the administrator 16 or some other individual.

The funeral services page(s) 22 may include pertinent information regarding a wake, a church service, a memorial service, an interment, etc. This information may include locations, dates, times, etc. Information about the deceased user's next of kin and/or surviving or predeceased relations may also be included. The funeral service page 22 may include a picture of the deceased user 22 as well as additional biographic information. A cause of death may also be included.

The funeral services page(s) 22 may also include an obituary notification system. The obituary notification system may provide transmission of the pre-written obituary, the parting message, or the information regarding the wake, memorial service, funeral service, interment, or other event. Additional information may be included as has already been described and as would be understood in the art. The obituary notification system may provide the information through the funeral services page(s) 22 or by another means as is described more fully below.

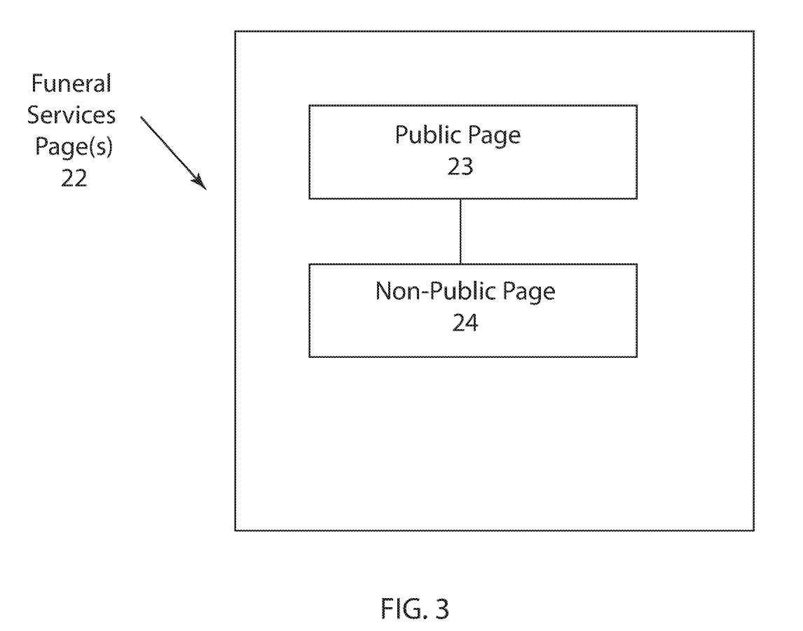

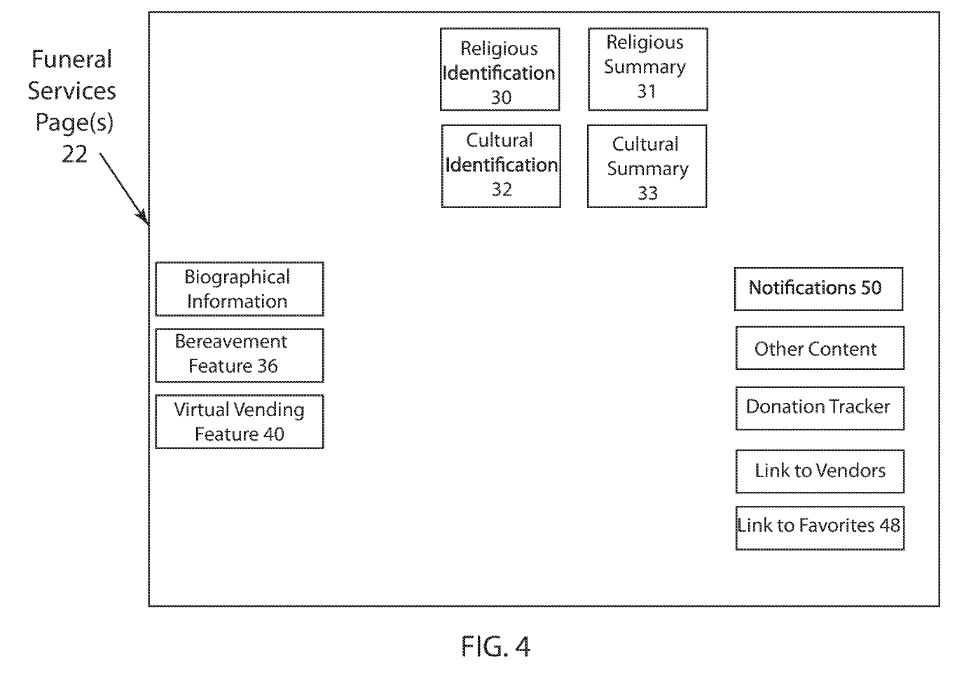

As described hereinabove and as shown in FIG. 3, the funeral services page(s) 22 may include both a public page 23 and a non-public page 24. In other embodiments, only a public page 23 may be provided. For example, if the deceased user's funeral is not going to be open to the general public, the public funeral service page 23 may merely present a message from the user 14 or the administrator 16 as well as a picture and selected biographical information. Additional features described herein may also be included in the public funeral services page 23 at the user's or the administrator's option. More specific details may be provided in the non-public funeral services page 24 which are not available to the public. FIG. 4 depicts some of the information that may be included on the funerals services page(s) 22.

For example, the non-public page 24 may be limited to close family members and friends, and the server 200 may prevent other individuals from accessing certain information (or any information) regarding the user 14 or the non-public page 24. Methods of restricting access may be used as is well-known in the art; these may include requiring an invitation to view the page, requiring a password to view the page, allowing only other individuals who have their own account 12 to view the page, only allowing certain other accounts 12 to have access to or to view the page.

A non-public page 24 may be preferred for a variety of reasons. If the deceased user 14 was a well-known or famous individual, the family may wish for privacy from unrelated individuals. If the user 14 died of a certain illness or condition, the user 14 or administrator 16 may wish for some individuals to know, but not for the general public to know. The user 14 or administrator 16 may not wish for the public to have access to pictures, photographs, or videos which may be uploaded to the account 12. The family may wish for a private ceremony honoring their loved one, and so may prefer that the time and location of any services are not published.

In one embodiment, the user's account may include both a public funeral services page and a non-public funeral services page. Access to the non-public services page may be controlled by the user before death or by the administrator after death. Access may be controlled, as described above, including through the use of a verification process such as a password, by an invitation-only process, or by any other suitable means.

The funeral services page 14 may also include an identification of the deceased user's religious identification 30, meaning an indication of what religion the user 14 subscribed to or considered themselves a part of. The funeral services page(s) 22 may also include a religious summary 31 feature. The religious summary 31 feature may include an explanation of the tenets of the deceased user's religion. It may also include information detailing the religion's specific customs regarding death, interment/cremation, grieving customs, etc. Information may also be included detailing the religion's view of the afterlife or lack thereof. Further, the religious summary 31 feature may include typical funeral customs, gift customs, or traditional ways of honoring the deceased. The information included in the religious summary 31 may be provided directly within the funeral services page(s) 22, or the funeral services page(s) 22 may link to other sites containing information. For example, if the user 14 lived in the United States and was a Roman Catholic, the funeral service page 22 may link to the Bereavement and Funerals page provided by the United States Conference of Catholic Bishops. Similar information may be provided for users of other nationalities or religions.

Cultural identification 32 and cultural summary 33 features may also be provided. The cultural identification 32 feature may indicate the culture or cultures with which the user 14 identified, whether national, familial, ethnic, or social. The cultural summary 33 may provide similar information as the religious summary 31 feature (but regarding the deceased user's national, familial, ethnic, cultural, or social identification) such as funeral customs, gift customs, etc. The information included in the cultural summary 33 may be provided directly within the funeral services page(s) 22, or the funeral services page(s) 22 may link to other sites containing information. For example, the funeral services page(s) 22 may link to the Death: Cultural Traditions page provided by PBS.org. Similar information may be provided for users of other cultural or ethnic groups.

In another embodiment, the funeral services page(s) 22 may include a soundtrack. The soundtrack may include music or audio of any type. The soundtrack may be predetermined, random, or may allow the user 14 or administrator 16 to select certain preferences for determining what audio to include. The funeral service page 22 may also include video, whether by links to separate pages, a video display included directly within the page, in a pop-up location, or in a sidebar or background location of a page. Video content may include videos of the user 14, the user's family or friends, videos the user 14 found to be inspiring, motivational, or touching, eulogies regarding the user 14, or any other content.

In one embodiment, the user 14 may create video content, audio content, visual content, a combination thereof, or any other type of content. This content may be uploaded to the account 12, but may not be immediately posted on the funeral services page(s) 22. In a further embodiment, the uploaded content may become available on the funeral service page(s) 22 at a later point. Posting to or availability on the funeral services page(s) 22 may occur in response to an action taken by the user 14 or the administrator 16, or may be done automatically by the memorial website system 10 in response to a triggering event. For example, the user 14 may create a video wishing another individual a happy birthday. The memorial website system 10 may use social media (such as the individual's own memorial website system account 12 or another social media account) to determine the individual's birthday, and may automatically post or make available the created video on that day. Similarly, the user 14 may create a video celebrating a holiday such as Christmas, Valentine's Day, or The Fourth of July. The memorial website system 10 may determine an appropriate time to post these videos or make them available. Instead of a video, audio content may be used, as well as visual content such as a picture, painting, screenshot, etc. Further, a user 14 may have content that they would like to upload in response to a conditional triggering event, such as if an acquaintance graduates or has a child.

In a further embodiment, there may not be a “correct” time to post the content, such as a birthday, a holiday, special occasion, or an anniversary. Instead, the memorial website system 10 may be enabled to determine when to release or post the content based on some other triggering factors. In one embodiment, the memorial website system 10 may use social media (both the memorial website system 10 and other social media accounts) to determine the when to release content. For example, the user 14 may have content which is known to be meaningful or uplifting to another individual. The user 14 may wish for the content to be posted or displayed at a time or times when the individual is depressed or having a difficult time. The memorial website system 10 may use social media to determine if the individual is struggling or is unhappy. This may be done by analyzing posts, statuses, messages, comments, likes, tweets, shares, and other features typically used on social media sites. The memorial website system 10 may analyze these to determine if posting the content would be appropriate. This may be accomplished by analyzing the individual's actions and interactions on social media or the lack of such actions or interactions. For example, if the individual is normally very active on social media, a lack of activity on social media may be indicative of an abnormal state of mind. Similarly, if the individual typically shares many statuses, photos, videos, or other content, but has not done so recently, the memorial website system 10 may determine that the content should be shared. Social media activity may be monitored in other ways as well, such as by the actual meaning of the social media content that is generated, the use of emoticons or language, the accounts with which the individual interacts, and many other ways that are understood in the art. It will be understood that the user's content may thus be automatically used by the memorial website system 10 in a variety of interactions with other individuals and for a variety of reasons, not limited to the use of the content to cheer up a depressed individual. The content may also be posted or displayed to celebrate an achievement, to celebrate with a happy individual, to provide confirmation of a thought or feeling, or for any other reason. The user's content may also be shared privately instead of being posted or made publically available.

In one embodiment, the memorial website system 10 may include a feature whereby the user 14 may input autobiographical entries prior to their death. In one embodiment, autobiographical entries may be entered by typing or otherwise keying information into the memorial website system 10. In another embodiment, autobiographical entries may be entered orally, such as by use of a speech to text program. Autobiographical entries may be entered using any other known data input mechanism, and may be stored by the memorial website system 10 using any known storage mechanism.

In one embodiment, autobiographical entries may comprise information given in response to a questionnaire 651. The questionnaire may direct the user 14 to answer simple questions such as “Where were you born?”, “What high school did you attend?”, or “What is your favorite sports team?”. In another embodiment, the questionnaire may direct the user 14 to provide more open-ended responses. For example, the questionnaire may instruct the user 14 to discuss a memorable childhood event, a specific trip or vacation, how the user 14 felt about the president when they were in college, how the user 14 felt about a specific law that was passed during the user's lifetime, etc. In another embodiment, the questionnaire may simply ask the user 14 what they would wish to tell someone viewing their account 12 ten years from the current date. Still further, the questionnaire may provide no further prompt than asking the user 14 what the user 14 wishes to talk about. An example of such a prompt would be “What's on your mind?”.

The questionnaire may be presented to the user 14 in a variety of formats. For example, the questionnaire may be text appearing on a computer screen, smartphone screen, or other device. In another embodiment the questionnaire may be presented to the user 14 in an audio format, such as a recorded question which is played through a speaker. The audio format may more closely approximate a conversation with another human, and thus may facilitate longer and/or more detailed autobiographical entries 65.

The questionnaire may contain multiple questions. In one embodiment, the user 14 may not be required to answer certain questions or may not be required to answer any questions. In one embodiment, the questionnaire may serve to facilitate the user's comfort in starting an autobiographical entry 65. Some users 14 may prefer to not use the questionnaire at all, and may select that as an option. In another embodiment, the user 14 may begin typing, talking, or otherwise entering information, even if the information does not pertain to the questions or the questionnaire 651.

A user 14 may prefer to respond directly to the questionnaire and/or limit the response to the question(s) presented. A different user 14 may prefer to respond to the questionnaire in a more roundabout manner and may include a variety of related or unrelated information. In one embodiment, the questionnaire may respond to the user's answers or autobiographical entry 65, much like a human would respond to conversation with another human. In one embodiment, this may facilitate longer and/or more detailed autobiographical entries 65. In this embodiment, the questionnaire may prompt the user 14 to respond to a new and/or different question at various times. For example, in one embodiment the questionnaire may present the user 14 with a new question once the previous question is answered. In another embodiment, the questionnaire may present the user 14 with a new question every time the user 14 logs onto their account 12. In a still further embodiment, the questionnaire may present the user 14 with a new question at other intervals or even random intervals. These questions may be presented in audio format or text format. They may be sent only when the user 14 is logged onto the memorial website system 10 or they may be sent by text, email, other social media sites, or other means as are well known in the art.

In another embodiment, a user 14 may wish to be able to provide a more narrative autobiographical entry 65. In this embodiment, the questionnaire may provide questions to the user 14 with more time in between questions or may cease to present questions to the user 14 entirely. In one embodiment, the user 14 may have the option of selecting when the user 14 would like to receive a new question.

The memorial website system 10 may analyze the autobiographical entries 65. The memorial website system 10 may also analyze other account information. For example, the memorial website system 10 and may identify key terms 652. Key terms may be established based on a variety of algorithms. A key term may refer to any piece of information which would be relevant in connecting the user 14 to other users, any information that would be of interest to an individual viewing the user's account 12, or any other information. By way of example, a date or year of birth may be a key term 652, the year the user 14 graduated high school or college may be a key term 652, where the user 14 was born or grew up or owned a house may be a key term 652, dates that user 14 served in the military or played for a specific sports team or attended a specific institution may be key terms 652, where the user 14 was stationed or vacationed may be a key term 652. Similarly, the user's opinions and feelings on specific topics such as sports teams, political representatives or parties, historic events, laws, musicians, celebrities, etc. may be key terms 652. Phrases, words, or terms which are used frequently by the user 14 may be determined to be key terms 652. In a further embodiment, the memorial website system 10 may be able to recognize words in other languages, slang words, and similar unique words and identify these as key terms 652.

A user's autobiographical entries may be posted to the user's account 12 as has been described above. The autobiographical entries may be posted to the funeral services page(s) 22, to the memorial profile 26, or to both. The user 14 may choose where the autobiographical entries are posted, when they are posted, and which individuals may access the autobiographical entries 65.

In one embodiment, the autobiographical entries may be searchable. In one embodiment the search function may be limited to searches for key terms identified by the memorial website system 10. In another embodiment, the search function may extend to any search term. In one example of how and when the search function may be used, a user 14 may enter a detailed autobiographical entry regarding New York Jets football games the user 14 attended during the 2014-2015 season. An individual viewing the user's account 12 after the user 14 has deceased may wish to know the user's thoughts on a specific player. The individual could search the user's autobiographical entries or the user's account 12 for words such as “New York Jets”, “Jets”, “football”, or even the player's name. These words may have been identified as key terms or they may simply be present in the autobiographical entries 65, and the search function may return the locations of these words. The individual may then be able to read pertinent portions of the deceased user's autobiographical entries and determine how the user 14 felt about the player, i.e. whether the user 14 liked the player, whether the user 14 thought the player was talented, whether the user 14 thought the player was a good fit for the New York Jets, what the user 14 thought of the players stats or his contract, etc.

In one embodiment, the memorial website system 10 may use the autobiographical entries to generate the funeral services page(s) 22, the memorial page 26, any other part of the user's account 12, or any content on or associated with the user's account 12. For example, the memorial website system 10 may use the autobiographical entries to determine the user's religious identification 30 and to provide a religious summary 31. Such determination may be accomplished by a processor 191, or other device known in the art. Similarly, the autobiographical entries may be used to determine the user's cultural identification 32 and to provide a cultural summary 33. Further, the autobiographical entries may be used to generate a portion of the user's biographical information.

The funeral services page(s) 22 may include information about donations, contributions, or actions that may be undertaken in memory of the deceased user 14. Some of these may overlap with the religious summary 31 or cultural summary 33 features, or they may be entirely user specific. The funeral services page(s) 22 may be configured to include a feature whereby such donations, contributions, or other actions may be taken. Alternatively, the funeral services page(s) 22 may link to other websites or webpages on which donations may be accomplished. For example, an individual visiting the funeral services page(s) 22 may be able to donate money to a specified charity, make a contribution to the deceased user's family for funeral expenses, purchase flowers for the funeral service, arrange for food services for a memorial service, arrange for the planting of a tree in the user's memory, etc.

The funeral services page(s) 22 may allow an individual to make donations directly on the funeral services page(s) 22, or it may require navigation to another site. In one embodiment, the user's account 12 may be connected to a specific charity selected by the user 14 or the administrator 16. Donations to the charity may be tracked by the memorial website system 10, and the system 10 may have features to indicate the level or amount of donations received. For example, if a user 14 or administrator 16 selects the American Cancer Society as the specified charity, the memorial website system 10 may indicate the selection on the account 12. This indication of the charity may be done by an icon, a banner, a border, a ribbon, a button, or other feature displayed on the webpage of the account 12. Further, the memorial website system 10 may track the amount of donations and change the indication of the charity accordingly. For example, there may be different tiers based upon the amount donated with the indication of the charity having a different color for each tier. Alternatively, the amount donated may be indicated in a variety of other ways as would be well understood in the art. For example, the account 12 may include a ticker-type notification of the amount. In another embodiment, the account 12 may display a meter which fills up as donations are received. Still further, the memorial website system 10 may increase the size of the notification in response to increased donations. Additional means of displaying the amount may be used.

The memorial website system 10 may allow the user 14 to customize the donation scheme. For example, the system 10 may allow the user 14 to pre-set how much of the donation goes to which charity or other cause. In one embodiment, the user 14 or administrator 16 may instruct that a first percentage goes to a first cause, while a second percentage goes to a second cause. The user 14 or administrator 16 may instruct that a certain monetary amount is to go to one charity, or may put a limit on how much a first charity may receive before donations will be shifted to a second charity. In a different embodiment, the user 14 or administrator 16 may pre-set conditions such that donations from immediate family go to one charity while donations from others go to a different cause. Other ways of breaking up the amount of donations to different charities may also be used.

The funeral services page(s) 22 may also link to outside vendors to assist an individual in making a purchase of flowers, cards, or other sympathy gifts. Companies providing these items may work with the memorial website system 10 to offer discounts (which may be referred to as “bereavement pricing”) or they may pay the system 10 in order to have their advertisements displayed.

The funeral services page(s) 22 may also include a bereavement feature 36. The bereavement feature 36 may include discounted rates (bereavement pricing) on flights, taxi cabs, limousines, busses, and other forms of transportation; hotels, motels, and lodging arrangements; as well as flowers, cards, and other goods or services. These discounted rates may be offered only to authorized or validated individuals attending the funeral or other memorial service of the deceased user 14. A variety of methods may be used to ensure that the general public does not take advantage of the discounted rates. For example, in one embodiment the individual may be required to pay full price upfront. Upon attending the funeral or other service, a funeral home employee or a funeral director may provide them with a bereavement code. The bereavement code may entitle them to a refund or rebate of a portion of their upfront payment. Alternatively, the bereavement code may be provided beforehand and used to obtain a discounted rate upfront. In another embodiment, the bereavement code may be provided to the administrator 16 of the funeral services page(s) 22. In this embodiment, the administrator 16 may be responsible for issuing the bereavement code to authorized individuals, whether before or after purchase of the pertinent services.

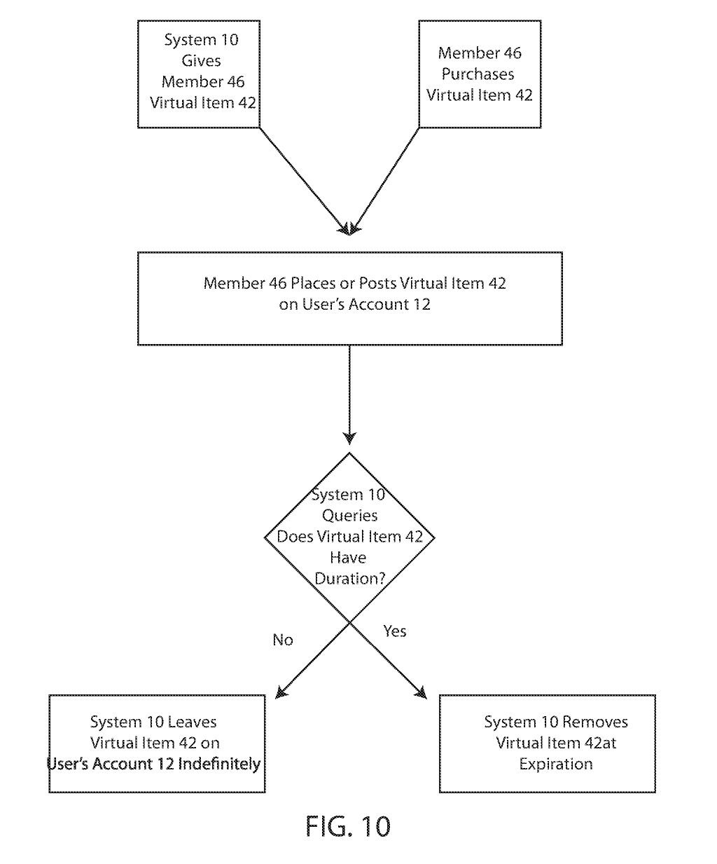

The funeral services page(s) and/or the memorial profile 26 may also include a virtual vending feature 40. The virtual vending feature 40 may allow for the placement of certain virtual items 42 on the user's account 12 or on one or more page(s) of the memorial website system 10 as shown in FIG. 10. These may be placed by any individual interacting with the user's account 12. For example, an individual may be able to place a virtual e-candle on the user's account 12 or on one or more page(s) of the memorial website system 10. The e-candle may call to mind large candle vigils often conducted in memory of a deceased individual or a small and private lighting of a candle in memory. The e-candle may be of various shapes, colors, or sizes, just as an individual would be able to select from a multitude of candle options in real life. Conversely, the user 14 or the administrator 16 may specify certain options that they would prefer, or the user 14 or the administrator 16 may limit the options. For example, for a user 14 whose favorite color was purple, the user 14 or administrator 16 may instruct the memorial website system 10 to only allow purple e-candles to be placed on the account 12. The e-candle may be a static image, or it may be an image that represents a live flame—a moving, flickering, changing depiction of a lit candle. Further, the e-candle may change over time. For example, the e-candle may become reduced in size or may grow dimmer the longer it is on the account 12. The e-candle may thus appear to run down much like a real candle.

The virtual vending feature 40 may also allow for the virtual placement of various other virtual items 42. In addition to e-candles, the virtual items 42 may include e-flowers, e-cards, e-crosses, among others. Further, electronic representations of religious symbols, cultural icons, ethnic icons, honorary symbols, flags, coins, grave markers, tomb stones, plants, animals, elements, professional badges, etc. may be included. A plurality of options may be available as discussed with the e-candle—color, shape, size, arrangement, etc. Available options may be chosen or limited by the user 14 or administrator 16. Like the e-candle, these may be static or they may be a moving icon or image. For example, a plant may grow and then age; a flower may lose petals; a tree may lose leaves, may flower and then bear fruit, may fall down, etc.; an animal may move around the page in a realistic manner; etc.

The memorial website system 10 may provide a number of virtual items 42 to individuals who use the memorial website system 10 and have their own account 12, also called members 46. Some virtual items 42 may be provided for free or according to certain conditions. For example, in one embodiment, a member 46 may be given a selection of virtual items 42 when they sign up for the memorial website 10 or when they make their own account 12. The member 46 may then place these items on other member's accounts or other page(s) of the memorial website system 10. The member 46 may be given additional virtual items 42 for accomplishing certain tasks such as logging in, inputting certain information into their account 12, selecting an administrator 16, updating their religious identification 30 or cultural identification 32, commenting on another member's account 12, etc., or based upon the amount of time they spend on the memorial website system 10. Virtual items 42 may also be provided to members 46 on the basis of the amount of time that the members 46 are signed up to the memorial website system 10. For example, every week, day, month, or year, a member 46 may be provided with a new virtual item 42, such as an e-candle. Virtual items 42 may also be available for members 46 to purchase from the memorial website system 10. These purchased virtual items 43 may have advantages over other virtual items; for example, they may be larger, they may have additional color options, they may be more intricate, etc.

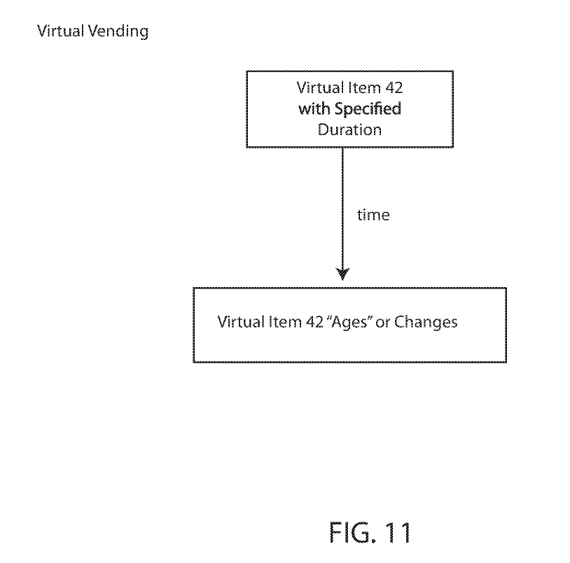

Virtual items 42 may also have a durational component as shown in FIG. 11. The virtual items 42 provided for free or for accomplishing certain tasks on the memorial website system 10 may be temporary. For example, some e-candles may only last for a day, a week, or any other time after being placed upon a member's account 12. Purchased virtual items 43 may have a longer duration or may stay on the account 12 indefinitely.

In addition to simply expiring, the virtual items 42 may change based on how long they have been on the account. For example, an e-candle may become dimmer and may burn down as it remains on the account 12. An e-flower may wilt or lose its petals; and a plant may similarly wilt and die. Other virtual items 42 may change in a way that would reflect the effect of the passage of time on a real life item—a cross, tomb stone, or grave marker may begin to crack or fade, may grow moss or other vegetation, may become more difficult to read, etc; an animal may grow older or move around the page less frequently.

In one embodiment in which flowers and other plants are used, the petals and leaves may fall off of the virtual items 42, but may remain on the account 12. For example, they may fall to the bottom of the page, may collect in the corners of the page, etc. These interactions may be based on whether the virtual item 42 was free or was a purchased virtual item 43, based on how many virtual items 42 have been posted, based on the user's or administrator's selected settings, the individual or member who gave or posted the virtual item 42, or a variety of other factors.

These interactions may remain on the account 12, thus allowing the account 12 to change or “grow” as more virtual items 42 are added to the account 12. This may enhance other members' sense of interaction with the deceased user 14—members' may post virtual items 42 to the account 12 and the virtual items 42 may eventually change or enhance the deceased user's account 12. Examples of changing or growing the account 12 may include the following: changing a feature or visual layout of the page (i.e., the leaves or petals accumulating on the page); unlocking an additional feature or layout on the memorial website system 10 (i.e., an additional page, an additional type of page, additional space to upload content, etc.); unlocking additional virtual items 42 to be placed on the account 12 or other members' accounts (i.e., limited edition virtual items, virtual items with an increased duration, permanent virtual items, etc.); etc. These changes may happen automatically or may require user 14 or administrator 16 verification. The user 14 may, prior to death, select a preference of automatically allowing the changes or requiring action by the administrator 16.

The funeral services page(s) 22 may allow members 46 to link their accounts 12 with other members' accounts 12 or to bookmark certain accounts as Favorites 48. This may allow easy access and navigation to accounts frequently viewed. In one embodiment, the memorial website system 10 may provide notifications 50 to individuals based upon the accounts to which their account 12 is linked. Notifications 50 may be sent by email, text message, within the memorial website system 10 itself, may be displayed directly on one or both of the funeral services page(s) or the memorial profile 26, or by any other means.

In a further embodiment, the memorial website system 10, the funeral services page(s) 22, and/or the memorial profile 26 may include the obituary notification system previously referred to. The obituary notification system may provide transmission of a variety of information. In one embodiment, the information may comprise a simple notification that the user 14 has passed away. In further embodiments, the information may be a complete obituary, information about the next of kin, information about the memorial services, or any other information. The obituary notification system may provide the information through the funeral services page(s) 22, the memorial profile 26, or by other means. For example, in one embodiment, the obituary notification system may transmit the information simply by making the information available on the funeral services page(s) 22 or the memorial profile 26. Alternatively, the obituary notification system may provide the information by transmitting a message or notification 50 to individuals who have linked their account 12 to the now-deceased user 14. The message or notification 50 may be transmitted within the memorial website system 10 or by an outside means such as email, text message, or other social media site.

In a still further embodiment, the memorial website system 10 may use the user's account information and data or information from their other social media accounts to determine who should be contacted by the obituary notification system. For example, there may be instances where the deceased user 14 is not in contact with all of the user's former acquaintances, former co-workers, former schoolmates, relatives, or other individuals. These other individuals may have no way of knowing that the user 14 has deceased, though they may wish to pay their respects by attending a services or sending a card or flowers. The memorial website system 10 may be configured to generate a list of such potential acquaintances, and to provide them with the message or notification 50 from the obituary notification system. The obituary notification system and/or the memorial website system 10 may identify individuals to whom the message or notification 50 should be sent by analyzing the user's account 12 and autobiographical entries for key terms 652. The selected key terms may be compared to other accounts on the memorial website system 10 or other social media accounts to determine a list of individuals who should receive the message or notification 50 from the obituary notification system.

For example, a user 12 may discuss time spent at the University at Albany during the years of 2000-2003 or time spent at Camp Adder in Iraq while serving in the United States Army. One having skill in the art will readily recognize that a wide variety of other examples could be given. These pieces of information may be determined to be key terms as described above. The memorial website system 10 may compare the key terms of the user's autobiographical entries to the accounts 12 of other individuals or to other social media accounts. The memorial website system 10 may select one or more matching individuals 1. Matching individuals may mean an individual who meets a threshold number of similar or matching key terms 652. Continuing with the above examples, an example of a matching individual may be an individual who attended the University at Albany during the same years as the user 12 or for some period which overlaps with the user's time there. In the second example, a matching individual may be an individual who also served in Iraq and was stationed at Camp Adder. In a further example, a matching individual may match the user 12 in both categories, i.e., both attended the University at Albany during that time and served at Camp Adder in Iraq. In a still further embodiment, additional matching or similar key terms may be needed to determine that the individual is a matching individual.

The obituary notification system may then transmit the message or notification 50 to the matching individual.

In one embodiment, individuals may be required to “opt in” to receiving the message or notification 50 from the obituary notification system. In another embodiment, the obituary notification system may transmit the message or notification 50 regardless of whether the individual has elected to receive such transmissions.

In one embodiment, the memorial website system 10 may provide notifications 50 regarding traditional, religious, or cultural observances indicated by the user 14 or administrator 16. For example, in the Eastern Orthodox Religion there is a forty day mourning period for a deceased individual. Within the forty day mourning period, the third, ninth, and fortieth days have specific ceremonies attached to them. Further, additional ceremonies may be performed on the six month, one year, and three year anniversaries of death. The memorial website system 10 may provide notifications 50 of these events to a member 46 whose account 12 is linked to the deceased user's account 12, assisting them in remembering the deceased user 14 and with observing the customs of the user's religion.

The memorial website system 10 may also automatically update a user's funeral services page(s) 22 in addition to sending notifications 50. For example, in the above example of a user 14 with Eastern Orthodoxy as the chosen religion, the funeral services page(s) 22 may be updated with information on what observances should be conduct on each day. In a further embodiment, members whose accounts are connected with the deceased user may receive virtual items 42 on these special days. The virtual items 42 may be posted or displayed on the user's funeral services page(s) 22 or on elsewhere on the memorial website system 10.

In a further embodiment, the funeral services page(s) 22 may include a translation option. This option may allow an individual visiting the page to select a language and have the entire content of the funeral services page(s) 22 translated into that language.

As has been described, the funeral services page(s) 22 may be created, generated, or updated automatically based on information acquired by the memorial website system 10 from a variety of sources. Similarly, once a funeral services page(s) 22 has been created, it may be automatically removed after a certain period of time. Alternatively, it may exist indefinitely. In one embodiment, the funeral services page(s) 22 may be set up to expire after a set time period, such as one month, one year, or any other time period. In a further embodiment, the time period may be connected to the traditional, religious, or cultural observances so that the funeral services page(s) 22 expires after all of the observances associated with the account 12 have occurred. In other embodiments, the time period may expire before the observances have occurred. In this embodiment, the memorial website system 10 may still be able to send notifications 50 via email, text message, or through other features of the memorial website system 10 despite the fact that the funeral services page(s) 22 is no longer available or active.

In one embodiment, the memorial website 10 may not include both a funeral services page(s) 22 and a memorial profile 26 simultaneously; instead, the funeral services page(s) 22 may be displayed first (whether automatically after a determination of death, or by some action taken by the user 14 or administrator 16) and the memorial website system 10 may later automatically switch or convert to a memorial profile 26 (based on the options for the expiration of the funeral services page(s) 22 or some other option or action). Alternatively, a user's account 12 may comprise both a funeral services page(s) 22 and a memorial profile 26 simultaneously or in some other combination.

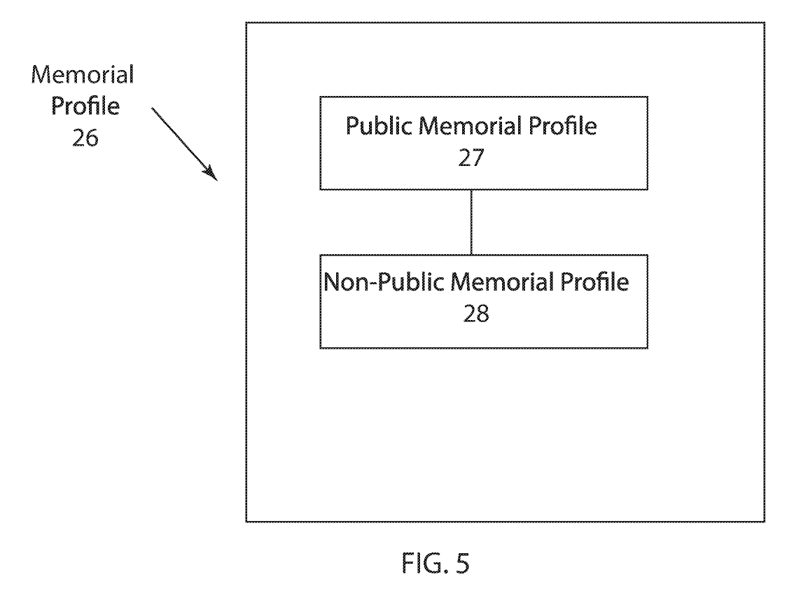

As shown in FIG. 1, the user's account 12 on the memorial website system 10 may also include a memorial profile 26. As shown in FIG. 5, the memorial profile 26 may either be public or non-public. Access to a non-public memorial profile may be controlled ahead of time by the user 14 and/or by the administrator 16 after the user's death.

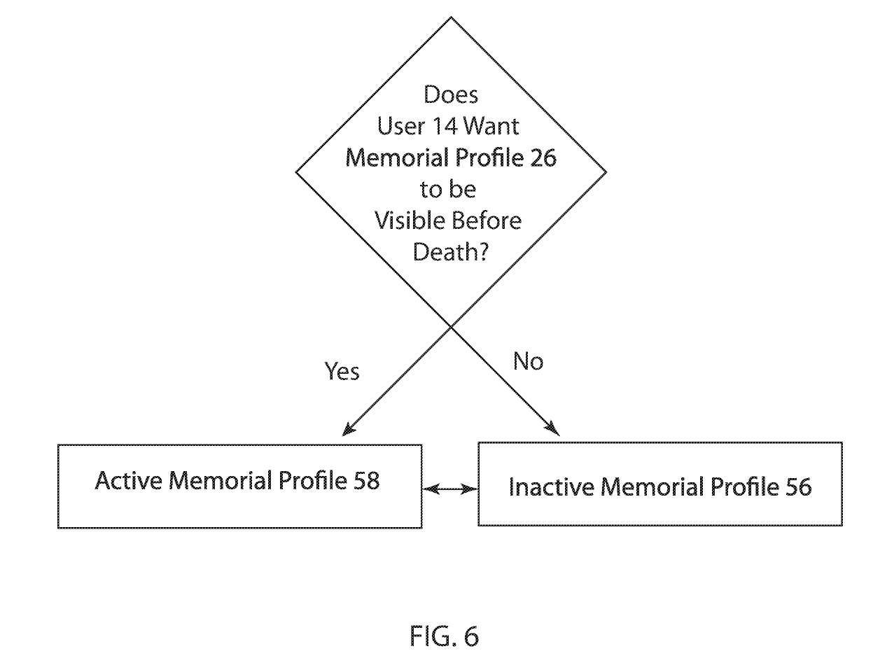

As shown in FIG. 6, the memorial profile 26 may be active before death if the user 14 wishes. An active memorial profile 58 is one in which other members (All members if the memorial profile 26 is public or authorized members if the memorial profile 26 is non-public) may be able to see the information input or posted by the user 14 or administrator 16. In another embodiment, the memorial profile 26 may not be active until the user 14 dies. In this embodiment, the memorial profile 26 may only be seen by the user 14 (and in some cases administrators 16) and may be an inactive memorial profile 56. An inactive memorial profile 56 may thus effectively only be a preview of what the memorial profile 26 will look like following the user's death, and may only be seen by the user 14 or administrator 16, or by other selected members 46. Other members 46 may only be able to see limited information such as the name or abbreviated information of an inactive memorial profile 56. In one embodiment, other members 46 may be able to link accounts 12 with the user's account 12, even if the user 14 has not deceased and the user's account 12 and/or page(s) and/or profile is inactive. This will facilitate a quick transition in the event of the user's death, and will allow the other member 46 to immediately see the memorial profile 26 the user 14 wished to be remembered by as well as the funeral services page(s) 22.

In a further embodiment, conversion from the inactive memorial profile 56 to an active memorial profile 58 may be accomplished automatically by the memorial website system 10. In one embodiment, the conversion may occur as a result of information acquired by the memorial website system 10, much like the automatic generation of the funeral services page(s) 22. For example, the memorial profile 26 may be automatically converted from inactive to active when the memorial website system 10 determines that the user 14 has deceased. Alternatively, the user 14 or the administrator 16 may have chosen a specific time after the user's death upon which the conversion should take place. In one example, this may be at the conclusion of the traditional, religious, or cultural observances. The memorial website system 10 may also be able to independently determine if all observances are complete and conversion should take place, even if the user 14 or administrator 16 has not specifically chosen a time frame. The conversion may also be linked to the timeframe, duration, or status of the funeral services page(s) 22. Still further, the conversion may be accomplished manually by the user 14, administrator 16, or some other individual.

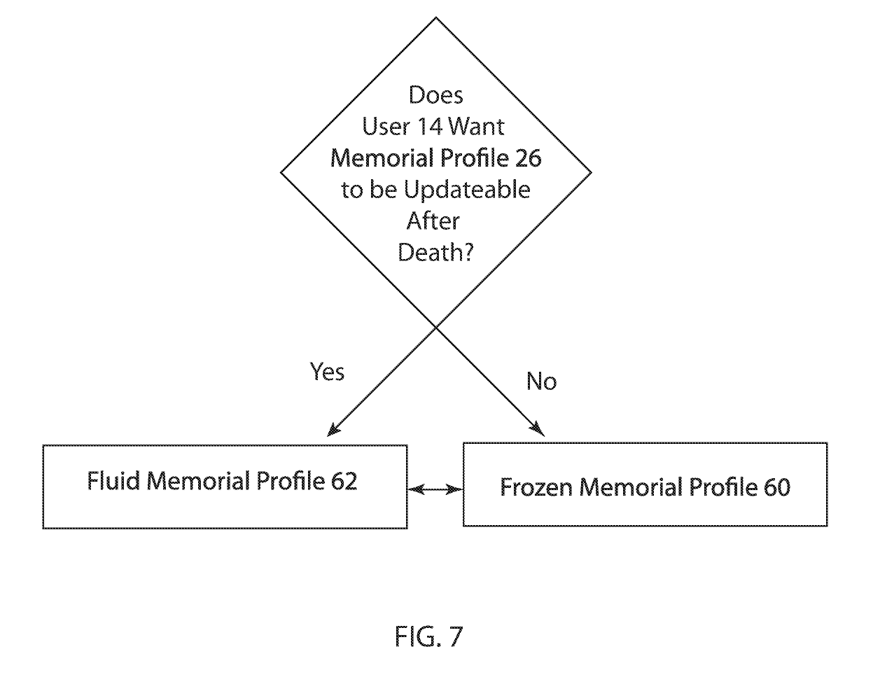

As shown in FIG. 7, the memorial profile 26 may also be either frozen or fluid after the user's death. A frozen memorial profile 60 is one in which the information may not be updated or changed by the administrator 16 after the user's death. A fluid memorial profile 62 is one that allows for further information to be posted by the administrator 16 after the user's death, or allows for some other change to occur based on the actions of the administrator 16, another member 46, or some other individual.

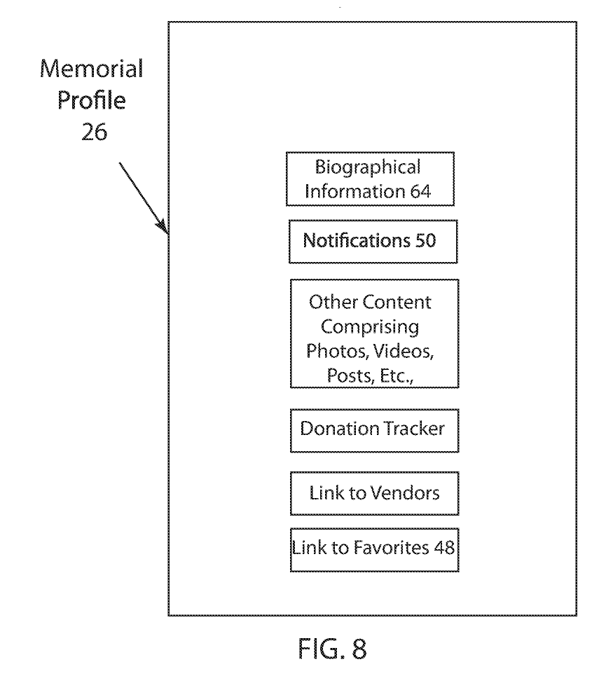

As shown in FIG. 8, the memorial profile 26 of a user's account 12 may include a variety of biographical information 64. In one embodiment, the biographical information 64 is predominantly autobiographical—it is inputted by the user 14 before death. Examples of biographical information 64 include date of birth; place of birth; special events that happened during the day, month, or year of birth; address of childhood home; places visited; schools attended; life events such as graduations, moves, marriages, birth of relatives, etc.; family information; career information; favorite activities, hobbies, passions; etc. The memorial profile 26 may include a family tree which links the user's account 12 to the accounts of other members 46. The memorial profile 26 may allow the user 14 to include pictures, videos, songs, music, and other information that the user 14 feels are important.

Like many common social media sites, the memorial profile 26 may be configured to conveniently display the user's information. For example, the account's memorial profile 26 page(s) may include a Home page which displays identifying information and other summary information. Additional pages may display further details regarding the user's Biography, Hobbies, Family, Pictures, Videos, Songs, etc. An individual may navigate between these pages through links or by other navigation means known in the art.

The memorial profile 26 may be linked to the funeral services page(s) 22. The memorial profile 26 may also include information about donations, contributions, or actions which may be undertaken in memory of the deceased user 14. The memorial profile 26 may be configured to include a feature whereby such donations, contributions, or other actions may be taken. Alternatively, the memorial profile 26 may link to other sites or pages on which they may be done. For example, an individual visiting the user's memorial profile 26 may be able to donate money to a specified charity or make a contribution to the deceased user's family.

The memorial profile 26 may allow an individual to make donations directly on the memorial profile 26, or it may require navigation to another site. In one embodiment, the user's account 12 may be connected to a specific charity selected by the user 14 or the administrator 16. Donations to the charity may be tracked by the memorial website system 10, and the system 10 may have features to indicate the level of donations received. For example, if a user 14 or administrator 16 selects the American Cancer Society as the specified charity, the memorial website system 10 may indicate the selection on the account 12. This indication of the charity may be done by an icon, a banner, a border, a ribbon, a button, or other feature on the memorial page 26. Further, the memorial website system 10 may track the amount of donations and change the indication of the charity accordingly. For example, there may be different tiers based upon the amount donated with the indication of the charity having a different color for each tier. Alternatively, the amount donated may be indicated on a variety of other ways as has already been described and as is well understood in the art.

The memorial website system 10 may provide rewards to members 46 who donate. In one embodiment, the system 10 may provide virtual items 42 to members who donate. The reward may be tied to the size or level of the donation or contribution. For example, a small donation may be rewarded with a virtual item 42 of limited duration while a large donation may have a longer duration or may be permanent. Other rewards may also be provided as a reward for donating, such as additional features or layouts for the funeral services page(s) 22 or the memorial profile 26, increased storage space for uploaded information, etc.

The memorial profile 26 may also provide a means by which the user 14 may interact with other members' accounts 12. For example, members 46 of the memorial website system 10 may link accounts 12. They may also designate other accounts 12 which they visit most frequently or would like to be able to easily access as Favorites 48. Further, the memorial profile 26 may include a section where members 46 may post or comment on either their own memorial profile 26 or another member's memorial profile 26. This feature may be limited to before or after Activation of the memorial profile 36 or the feature may be available at any time. Further, the ability to post or comment is optional and may be removed by the user 14 or administrator 16. The user 14 or administrator 16 may also have the ability to only allow certain members 46 to post or comment, to prevent certain members 46 from posting or commenting, or to remove posts or comments.

Members 46 may post or upload photos, videos, songs, or other information onto other members' accounts 12 as well as their own. In some embodiments this may be limited to before or after activation, or the feature may be available at any time. Further, the ability to post or comment is optional and may be removed by the user 14 or administrator 16. The user 14 or administrator 16 may also have the ability to only allow certain members 46 to post information, to prevent certain members 46 from posting information, or to remove posted information. The posting of this digital media will allow members 46 to share their memories of the deceased user 14 with other members 46 viewing the user's memorial profile 26.

In one embodiment, the memorial website system 10 may be configured to automatically retrieve information from the internet. Information automatically retrieved may include news articles, photos, videos, or other content pertaining to the deceased user 14. This content may be automatically posted to the account 12, whether on the funeral services page(s) 22, the memorial profile 26, or both. In a further embodiment, posting may require approval or some other action to be taken by the user 14 or the administrator 16. In one embodiment, the user 14 or the administrator 16 may be able to select preferences for what content should be retrieved, what content should be automatically posted, or what content should require approval. For example, the user 14 or the administrator 16 may select content based on type (news articles, opinion articles, sports articles, political analysis articles, etc.); based on source (such as newspaper articles, social media content, works by a specific author, etc.); based on content type (such as written content, video, pictures, audio content, social media content, etc.); or based on any other searching or filtering preference known in the art. Various time frames may be placed on the automatic retrieval. For example, retrieval may be limited to before death, after death, to a specific period after death, to a specific time period each year (anniversaries, birthdays, date of death, or other important dates), or other time frame. The automatic retrieval may also be configured to be triggered by a specific event, such as posthumous receipt of an award, an action by a descendant or relative, or by activation of the service by the user 14 or administrator 16.

In addition to interacting with other member's accounts 12 before death, the memorial website system 10 may allow for posthumous/postmortem interaction by the user 14. The interaction may be with another member 46 or with an individual who is not a member 46 on the memorial website system 10. The posthumous interaction may be a single event, multiple events, or recurring events. A posthumous interaction may be a message 68, a gift 70, or some other interaction. Further, posthumous interactions may be referred to as predetermined, contingent, or responsive as is described more fully below. In one embodiment, interactions may be taken by the memorial website system 10 through the internet 300, such as by sending a message over the internet, purchasing an item over the internet, sending money over the internet, etc. In one embodiment, interactions may be submitted to the administrator 16 for approval, or may be presented to the administrator 16 as interactions they may wish to undertake as the user's administrator.

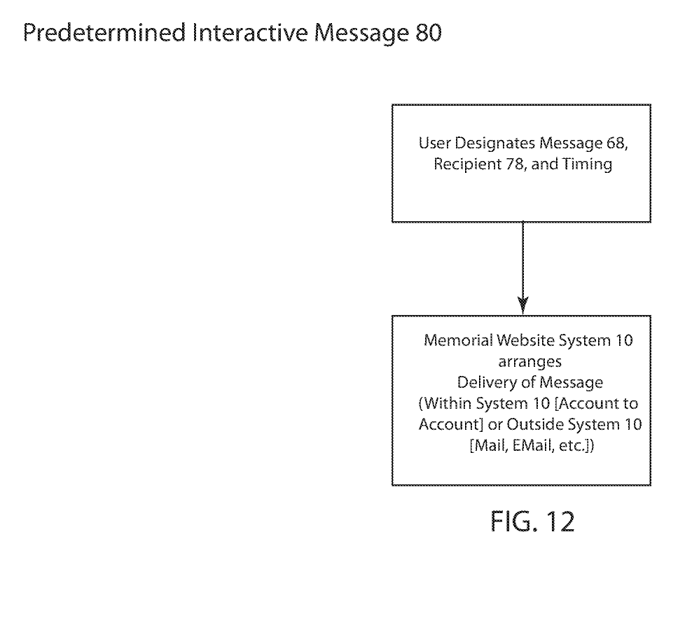

In one embodiment, the user 14 may wish to provide a message, letter, statement, or similar interaction, referred to herein as a message 68, to a recipient 78 upon or after the user's death. This may be predetermined by the user 14, in which case the message 68 may be called a predetermined interactive message 80. The steps of sending the predetermined interactive message 80 according to one embodiment are shown in FIG. 12 and described more fully as follows: The user 14 may, before death, choose to prepare the predetermined interactive message 80 using the memorial website system 10 and select when the predetermined interactive message 80 should be sent. For example, the user 14 may decide that if they pass away before a certain date or age, they want a first message conveyed to a specific recipient 78; however, if they die after a certain date or age they wish for a different message to be conveyed to the recipient 78 or for a message to be conveyed to some other second recipient. Similarly, a user 14 may wish to provide a message, letter, statement, or other interaction at some point after their death, whether on a specific occasion, a certain time after their passing, or at a recurring interval. The user 14 may wish to provide an entirely unique message at a certain point. Alternatively, they may wish for a generic message to be provided at other times. Generic messages may include messages such as “I love you”, “Happy Birthday”, etc. The memorial website system 10 may allow the user 14 to select occasions for which a predetermined interactive message 80 should be provided such as birthdays, anniversaries, holidays, and similar recurring events.

In one embodiment, the message 68 may be provided from the user's account 12 on the memorial website system 10 to the recipient's account 12 on the memorial website system 10. In other embodiments, the memorial website system 10 may instead direct that a letter be mailed to the recipient's address, work, PO Box, etc.; direct an email to be sent to the recipient's email address; provide a message to the recipient's account on a separate social media system; or provide for the message to be delivered through some other medium or system.

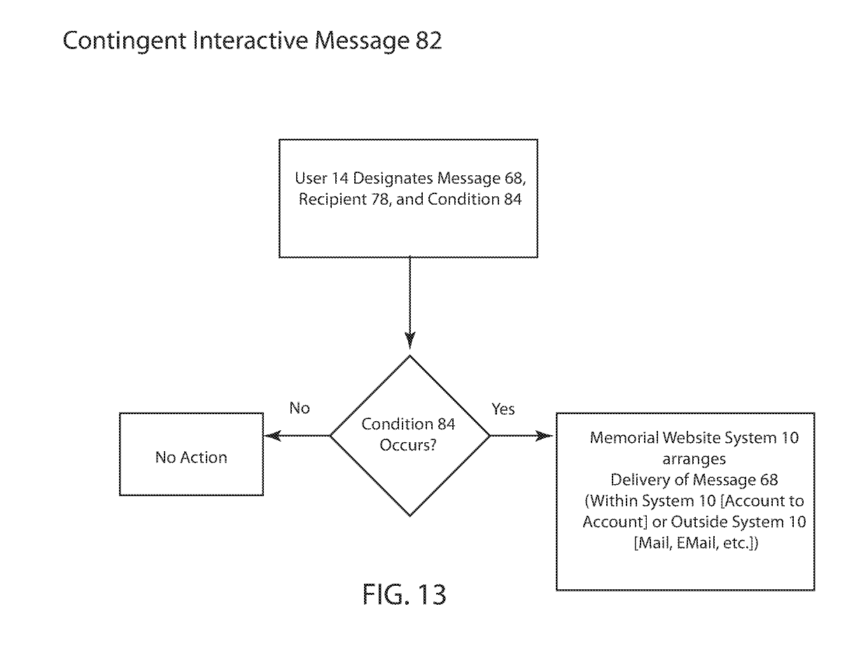

In another embodiment, the memorial website system 10 may allow the user 14 to construct messages 68 for non-recurring events and even for events that do not have an ascertainable date at the time of the user's death or which are entirely contingent on other factors. These interactions are referred to as a contingent interactive message 82 and may be released or delivered upon the occurrence of a designated condition 84. The steps of sending a contingent interactive message 82 according to one embodiment are shown in FIG. 13. The user 14 designates a message 68, a recipient 78, and a condition 84. When or if the condition 84 occurs, the memorial website system 10 takes action to deliver the message 68 to the recipient 78. For example, a user 14 may be able to instruct the system to provide a message 68 if the recipient 78 gets married in the future, if the recipient 78 graduates from high school or college, or if the recipient 78 has a child. Other conditions 84 may be used.

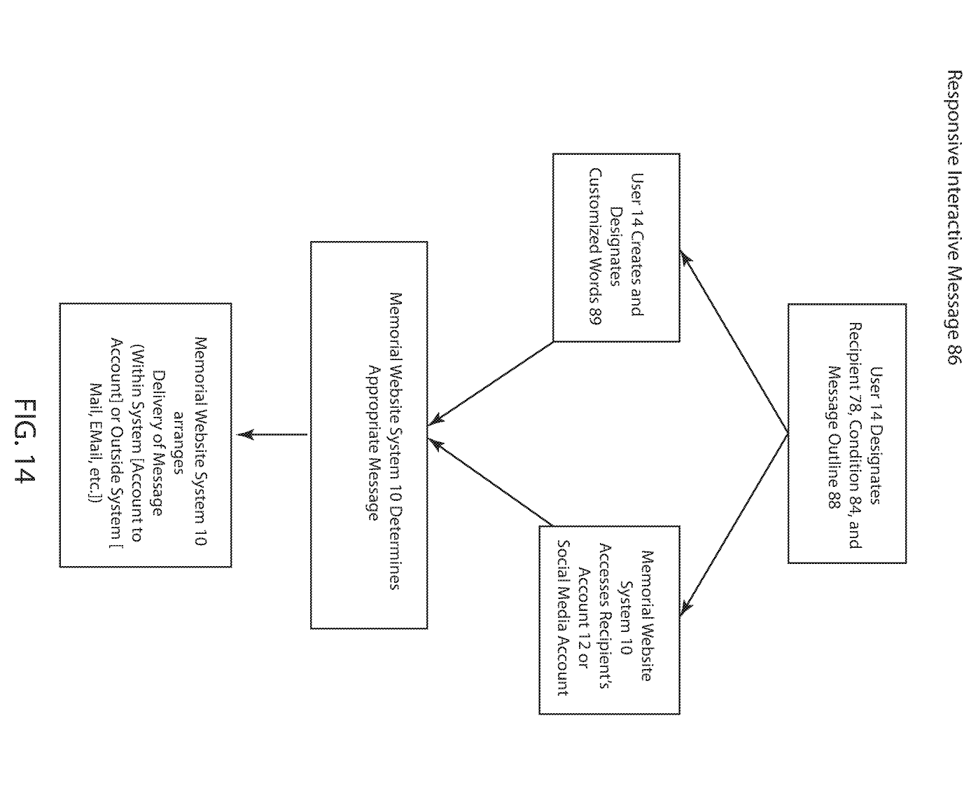

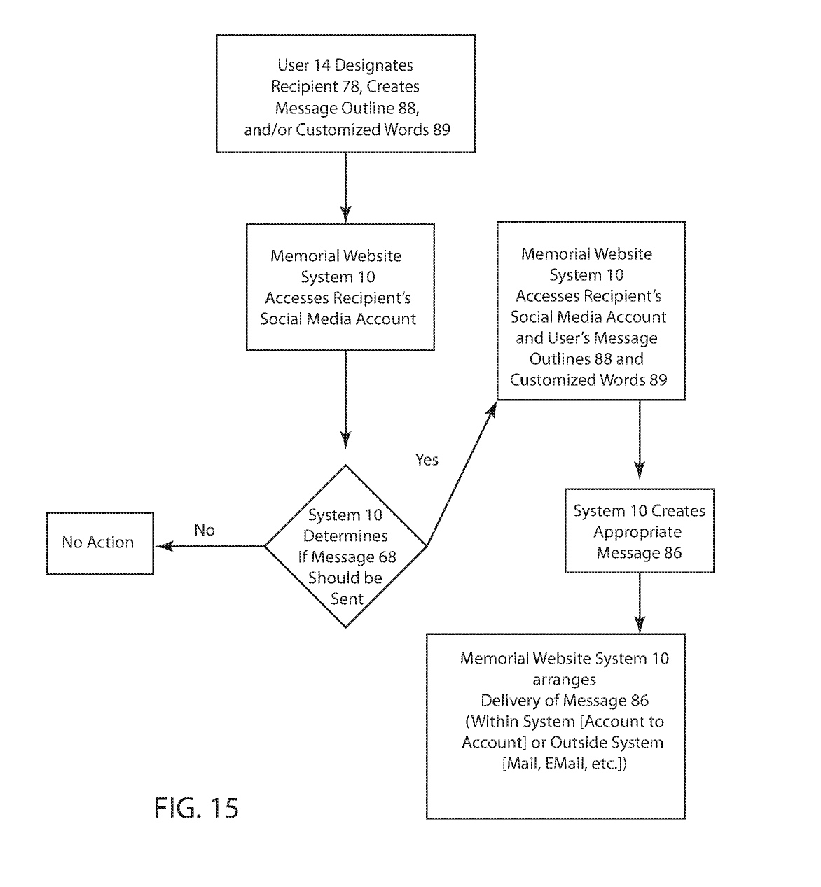

In a still further embodiment, the memorial website system 10 may allow the user 14 to interact with individuals via messages 68 which are not fully created until after the user's death, called a responsive interactive message 86. The responsive interactive messages 86 are constructed by the memorial website system 10 in response to occurrences in the recipient's life. In this embodiment, the user 14 may construct message Outlines 88 which may be adaptable to various life events. The steps of sending the responsive interactive message 86 according to different embodiments are shown in FIGS. 14 and 15. For example, the user 14 may create a variety basic message Outlines 88 that are applicable to one or more events such as “Congratulations!”, “Mazel tov”, “Cheers”, “I'm so proud of you”, “I love you”, etc. The user 14 may further provide a group of customized words 89 including phrases, nicknames, or other words that may be specific to the recipient 78 or to a group of recipients. In this embodiment, the memorial website system 10 may be able to construct the responsive interactive message 86 for the recipient 78 based on the user's message Outline 88 and the customized words 89 designated for the recipient 78.

The customized words 89 may also be generated based on the user's autobiographical entries 65. For example, the memorial website system 10 may determine that the user 14 uses specific words or phrases frequently or uses irregular or unique sayings. The memorial website system 10 may also detect differences in pronunciation, vocabulary, or syntax that may be the result of an accent or that the user is not speaking their native language. These differences may be included in the customized words 89. Customized words 89 may be generated based on key terms or based upon an analysis of the entirety of the autobiographical entries 65.

Further, the user 14 may provide the memorial website system 10 with specific times to send the responsive interactive message 86 or the system 10 may be instructed to provide a message at random times. Alternatively, the memorial website system 10 may have access to a social media account of the recipient 78, whether the recipient's own memorial website system account 12 or an account on another system. The memorial website system 10 may use the information from the recipient's social media account to determine when to send the responsive interactive messages 86 and also to determine appropriate content. For example, the memorial website system 10 may access the recipient's statuses, posts, comments, likes, shares, updates, changes to the their accounts, purchases, relationships, interactions with other social media accounts, in order to determine if the responsive interactive message 86 should be sent, as well as to customize the responsive interactive message 86. The memorial website system 10 may also be able to access the user's autobiographical entries and use the information therein to determine when to send the responsive interactive messages 86 as well as to assist in generating the appropriate content. Thus, the memorial website system 10 may be able to construct a unique and fitting message upon the occurrence of condition 84 as shown in FIG. 14, or the system 10 may even be able to determine that a message 68 should be sent and then also determine the unique and fitting message to send as shown in FIG. 15.

In a still further embodiment, the memorial website system 10 may be capable of providing messages in the form of comments. For example, Facebook users will be aware that a primary method of interaction is “commenting” on other users' posts, shares, status, etc. The memorial website system 10 may be capable of generating a comment and posting this comment in response to another user's social media content. The comment may be generated in any of the manners discussed above. For example and without limitation, it may be generated in the same manner as a predetermined interactive message 80, a contingent interactive message 82, a responsive interactive message 86, or in other manners. Customized words 89 and the user's autobiographical entries may also be used as has been described.

It will be understood that the process of commenting described above will enable the memorial website system 10 to comment on future events, activities, posts, shares, other comments, etc., on the user's behalf, even events and activities that occur after the user's death, or to which a response may become necessary or desirable after the user's death.

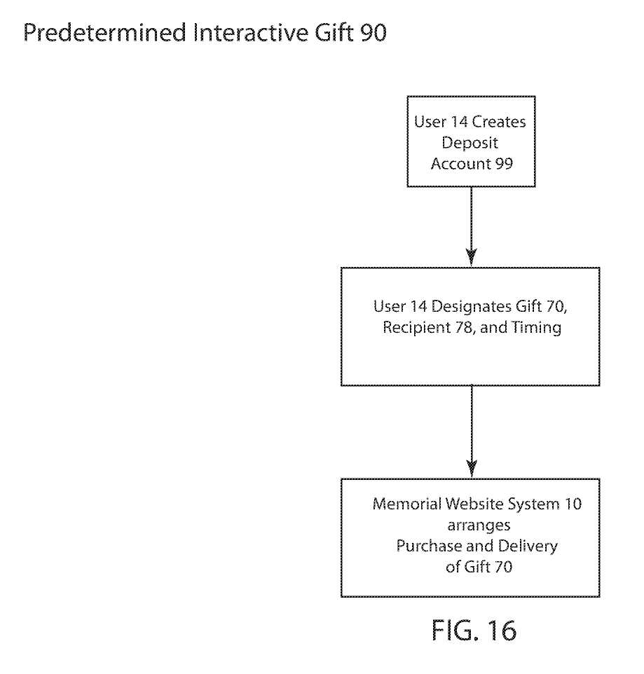

In another embodiment, a user 14 may decide that, should they die or after they die, they would like for the memorial website system 10 to send flowers, chocolates, or some other gift to the recipient 78 on the recipient's birthday or anniversary, on Valentine's Day, or on any other occasion. Such interactions may be referred to as a predetermined interactive gift 90 as they are set up before the user's death. In these situations, the user 14 may choose options on the memorial website system 10 to instruct the system to arrange for these gifts to be delivered. One embodiment of the steps of the predetermined interactive gift 90 is depicted in a flowchart in FIG. 16. Similarly to the predetermined interactive message 80, the user 14 designates a gift 70, a recipient 78, and a time when the gift 70 should be given.

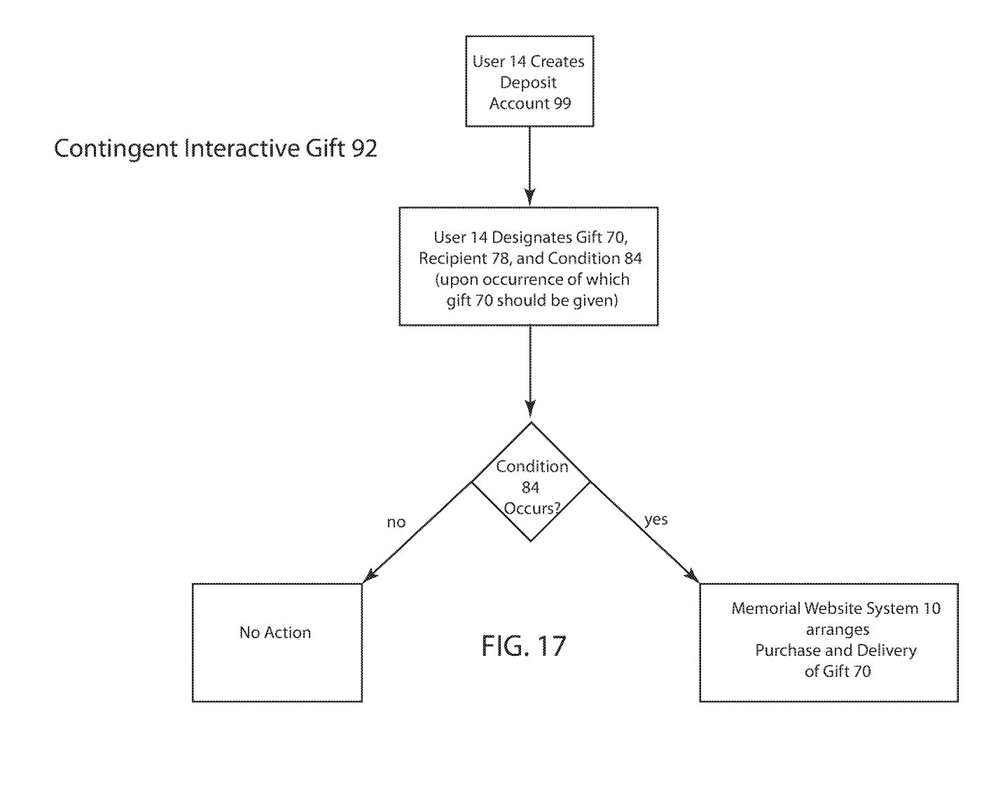

In a further embodiment, the memorial website system 10 may allow the user 14 to give gifts 70 for non-recurring events and even for events that do not have an ascertainable date at the time of the user's death or which are entirely contingent on other factors. These interactions may be referred to as a contingent interactive gift 92. For example, a user 14 may be able to instruct the system 10 to provide a specific gift 70 if the recipient 78 gets married in the future, if the recipient 78 graduates from high school or college, or if the recipient 78 has a child. One embodiment of the contingent interactive gift 92 is depicted in a flowchart in FIG. 17. Similarly to the contingent interactive message 82, the user 14 designates a recipient 78, a gift 70, and a condition 84 upon which the gift 70 should be given to the recipient 78.

In a still further embodiment, instead of arranging for a static predetermined interactive gift 90 or contingent interactive gift 92 to be made, the system 10 may provide a method for determining what gift 70 the recipient 78 might appreciate at a given time. This may be referred to as a responsive interactive gift 96. The responsive interactive gift 96 may be especially useful when the recipient 78 is the user's child, niece or nephew, or other young relative or acquaintance whom the user 14 may wish to provide with a gift 70. The age factor may often present an additional hurdle to the user 14, as the preferences of recipient 78 who is young at the time of the user's death are likely to continue to evolve much more than an older recipient 78.

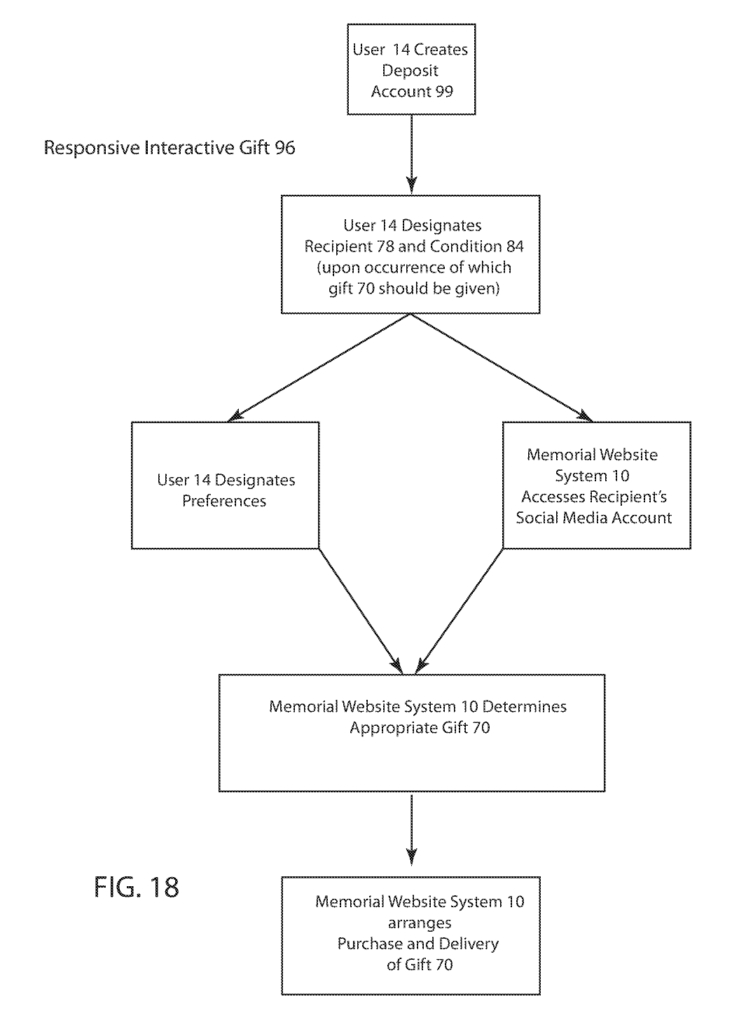

In one embodiment, the memorial website system 10 may be configured to access the recipient's own social media accounts, whether on the memorial website system 10 or other social media accounts on the internet 300. These accounts may also include the recipient's own autobiographical entries 65, if any have been entered. Using information gathered from these accounts, the memorial website system 10 may determine a gift 70 or gifts that the recipient 78 might like to receive at this time of the recipient's life. For example, the memorial website system 10 may analyze social media posts, comments, “Likes”, links, pictures, videos, “Shares”, shopping habits, other purchases, etc., to determine the recipient's current interests or needs. The system may then determine what the responsive interactive gift 96 should include. A depiction of one embodiment of a responsive interactive gift 96 is shown in FIG. 18.

In addition to an automatic determination of the responsive interactive gift 96 based on the recipient's social media information, in a further embodiment the memorial website system 10 may be able to interact with the recipient 78 to allow them to input, select, or otherwise indicate their own preferences. This may allow the memorial website system 10 to ensure that the recipient 78 receives a suitable responsive interactive gift 96, without removing the feeling of interaction with the deceased user 14.

Similar to the options for the user 14 to contribute to the responsive interactive message 86, the user 14 may contribute to the responsive interactive gift process by designating certain references. For example, in one embodiment, the user 14 may set a dollar limit or range, may limit gifts to a specific category, or may provide a specific list of what gifts to buy at what age/timeframe. In another embodiment, the user 14 may limit gifts to sports equipment, music equipment, school equipment, educational toys, or to any other category. The user 14 may further narrow down the scope of gifts that may be chosen by the memorial website system 10 for the recipient 78. For example, the user's selected preferences may limit sports gifts to a specific sport such as football, a team or teams from a specific area of the country, or to items associated with one specific team or player. The memorial website system 10 may also access the user's autobiographical entries in order to assist in determining an appropriate gift or to appropriately limit the potential gift. The use of the autobiographical entries may also enable the memorial website system 10 to choose a gift that would more closely match what the user 14 would have given the recipient if the user 14 was still alive to do so. For example, the memorial website system 10 may be able to analyze gifts that were given for similar occasions in the past, if these were recorded in the autobiographical entries 65. The autobiographical entries may also have records of the recipient's response to the gift, or accounts of the user 14 and the recipient enjoying a particular pastime, hobby, activity, food, drink, etc. The autobiographical entries may also assist the system 10 in eliminating certain gifts. For example, there may be items that the user 14 would never have purchased or given to the recipient based on a principle or a preference that is recorded in the autobiographical entries 65. The above-described embodiments may allow further control of the gift determining to be accomplished by the user 14, while still allowing the memorial website system 10 to vary the gift by year, other occasion, or according to the recipient's projected needs or wants. Further, the memorial website system 10 may thus account for the recipient's age or other condition as well as the technological, cultural, or fashion advances since the death of the user 14 in determining the details of the responsive interactive gift 96. In one embodiment, the memorial website system 10 may serve as a trustee or executor for an estate or account of the user 14.

The user 14 may instruct the memorial website system 96 to pay a bill for car insurance, college tuition, a car lease, a mortgage payment, school lunch money, or other similar necessity. Alternatively, the memorial website system 10 may be instructed to simply forward money to the recipient 78 for their use, similar to an allowance.

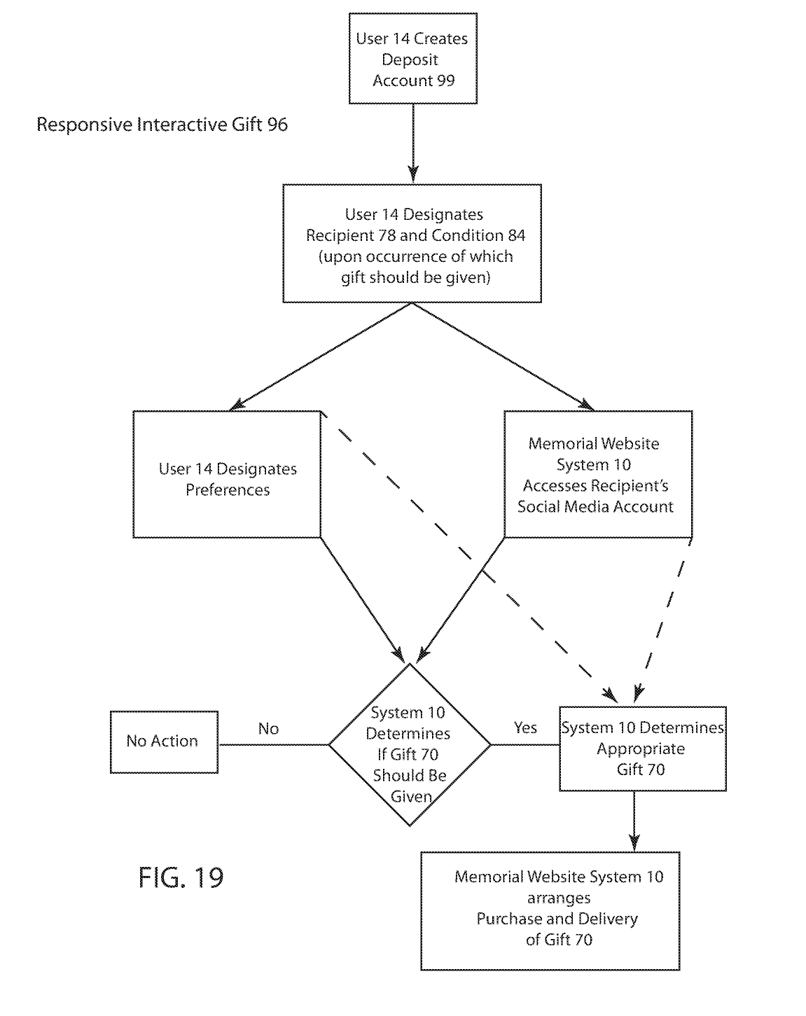

Much like the memorial website system 10 may be able to determine when the responsive interaction message 86 should be sent, it may be able to determine when the responsive interaction gift 96 should be given. This may again be based on information retrieved or accessed from the recipient's social media account. Thus, the memorial website system 10 may provide options that may be considered a combination of predetermined, contingent, and responsive. By way of example only, the system 10 may have a predetermined or contingent time to give a gift 70, but may be configured to use the recipient's social media account or other information to determine what gift 70 should be given. In another embodiment, the system 10 may responsively determine both when a gift 70 should be given and also determine what kind of gift 70 or what specific gift 70 should be given at that time. A depiction of an embodiment of this type of gift-giving is shown in FIG. 19.

In one embodiment, in order to accomplish the posthumous interaction 66, whether predetermined, contingent, or responsive, the user 14 may purchase the services in advance though the memorial website system 10. For example, the user 14 may pay the memorial website system 10 a sum of $1,000 to be used to buy birthday gifts of approximately $100 for at least 10 years. The memorial website system 10 may charge fees in addition to the amount deposited for gifts or the memorial website system 10 may be compensated by investing the deposited amount and earning interest until the gifts are purchased.

In one embodiment, the user 14 may have a deposit account 99 on the memorial website system 10 into which money is placed before death. This money may be designated for predetermined gifts, conditional gifts, responsive gifts, or another posthumous interaction 66. In other embodiments, the user 14 may have multiple deposit accounts 99 on the memorial website system 10, with each deposit account 99 designated for a specific gift 70, a specific recipient 78 or group of recipients, or for some other posthumous interaction 66. Alternatively, depending on pertinent law, the user 14 may be able to bequeath money or other assets into the deposit account 99.

Depending on the laws of the various jurisdictions in which the memorial website system 10 may be used, various types of deposit accounts 99 may be used. For example, in various embodiments the user's estate may own the funds, the recipient 78 may own the funds or have a recognized interest therein, or the funds may be transferred to a representative of the memorial website system 10 to hold and use according to the user's instructions. Additional possibilities may be used as will be understood in the art.

An individual may also be able to request an interaction with the user 14 or the user's account, even after the user 14 has deceased. For example, the memorial website system 10 may include a feature whereby an individual may ask the user's account 12 to respond as it believes the user 14 would. For example, an individual whose father is the now-deceased user 14 may wish to know the user's thoughts or feelings on a topic. Using the example of the sports player from above, the individual may wish to know what the user 14 thought of the player. Instead of simply searching the autobiographical entries of the user 14 for any relevant data, the individual may instead request that the memorial website system 10 respond to a question such as “What do you think of the player?”. The memorial website system 10 may then conduct the search of the autobiographical entries 65, including any key terms, and then construct an answer using the customized words 89, specific language from the autobiographical entries 65, or other information gathered from the autobiographical entries and the user's account 12. The answer may be constructed to mirror the user's actual speech habits, thoughts, and feelings, as recorded in the autobiographical entries 65.

In one embodiment, the memorial website system 10 may also use information from the user's other social media accounts in order to generate the answer or response.

In one embodiment, the memorial website system 10 may have enough content in the autobiographical entries to select a complete appropriate response from the autobiographical entries 65. For example, the memorial website system 10 may be able to find a response to a similar or even identical question and may simply reproduce the user's original response.

In one embodiment, the memorial website system 10 may be configured to provide the response in the user's voice. In one embodiment, this may be done by playing back audio files from the autobiographical entries 65. For example, where autobiographical entries have been entered by dictation, the audio file of the autobiographical entries may be saved for playback (even where the autobiographical entries are converted to text). Thus, if the memorial website system 10 is able to select a complete appropriate response from the autobiographical entries as discussed above, the memorial website system 10 may be able to provide the answer in the user's own voice by providing playback of the pertinent section of audio. In another embodiment, the memorial website system 10 may not be able to play back a complete response, and may instead combine words or phrases from different autobiographical entries or from different points of one autobiographical entry 65. These may be combined to form a response which may be played in an audio form.

In a further embodiment, the memorial website system 10 may be able to construct an audio reply in the user's voice without resorting to compiling audio files. For example, as will be understood in the art, after a substantial amount of audio autobiographical entries have been entered, the memorial website system 10 may be able to determine and reproduce the speaking voice of the user 14. The memorial website system 10 may then be able to create and play an audio version of the generated response or answer, even if the specific answer or even certain whole words were never included in the autobiographical entries by the user 14. As will be known in the art, the accuracy and precision of this feature may increase as the amount of spoken content is included in the autobiographical entries 65, i.e., as the sample size increases.

In yet another embodiment, the memorial website system 10 may be used to send gifts or messages during the lifetime of the user 14 or to provide other interaction between users. The memorial website system 10 may track these interactions. For example, the memorial website system 10 may track who the user 14 sends messages to, at what time the messages are sent, what the content of the messages are, etc. Similarly, the memorial website system may track who gifts are sent to, what category of gifts are given, when gifts are given, how much money is spent on gifts for particular users or particular occasions. The tracking may include information regarding the relation between the user 14 and recipient, as well as any other correlation between the user 14 and the recipient including the other interactions between the user 14 and the recipient, such as messages exchanged. For example, the memorial website system 10 may track and compare the frequency and cost of gifts with the frequency, length, and content of any messages exchanged between the user and the same recipient. Similarly, the memorial website system 10 may track connections between users, such as whether the users' accounts 12 are linked, whether the accounts 12 are part of the same family tree, and other connections that would be known to one experienced in social media connections.

Information tracked by the memorial website system 10 may be used to purchase/send a gift 70. For example, the memorial website system 10 may use the tracked information to determine if and when a gift 70 should be given as well as to determine what gift would correspond to a gift 70 that the user 14 would actually send. This information may then be used to suggest that the user 14 give the recipient a gift 70 or may be used to automatically purchase/send a gift 70 to the recipient 78. Similarly, the memorial website system 10 may be used to suggest or send messages to the recipient 78, based on prior messages and other interactions between the user 14 and the recipient 78.

Analysis of the tracked information may be done continuously by the memorial website system 10, such as by the processor 191. Analysis of the tracked information may be done before or after the death of the user 14, or during both times. For example, before the death of the user 14, in one embodiment, the memorial website system 10 may use the information to remind the user 14 to send a gift 70, message, or other interaction, and may be presented as a suggestion. After the death of the user 14, the memorial website system 10 may use the tracked information to automatically send a gift 70. In a further embodiment, this may be combined with the use of social media to determine an appropriate gift 70 as has been described above. In yet a further embodiment, the memorial website system 10 may use the tracked information to provide a suggested interaction (gift 70, message, or other interaction) to the administrator 16 of the account 12 of a deceased user 14. The memorial website system 10 may use the tracked information from interactions when the user 14 was alive to determine what interactions they would likely make, as well as the timing of the interactions, following the death of the user 14. Similar to the gift-giving scenarios described above, the memorial website system 10 may also access social media accounts (both on the memorial website system 10 and others such as Facebook, LinkedIn, etc.) of the user 14 and linked accounts 12 to determine when an interaction should occur or should be recommended.

The memorial website system 10 may be programmed to store and/or analyze information from the interactions of a user 14 from before the user's death. This information may then be used in conjunction with information from after the user's death, to determine whether additional interactions should be taken or recommended and if so, under what specific conditions and details. The memorial website system 10 may thus be able to respond to events and changed conditions after the user's death, in a way that reflects or approximates the response of the user 14 had they not died, or of the user 14 before their death.

The memorial website system 10 may be programmed to analyze information from the user's autobiographical entries as well. This information may be used in combination with the stored information from the user's interactions on social media to determine whether additional interactions should be taken or suggested, for example, gift-giving, message sending, or other interactions.

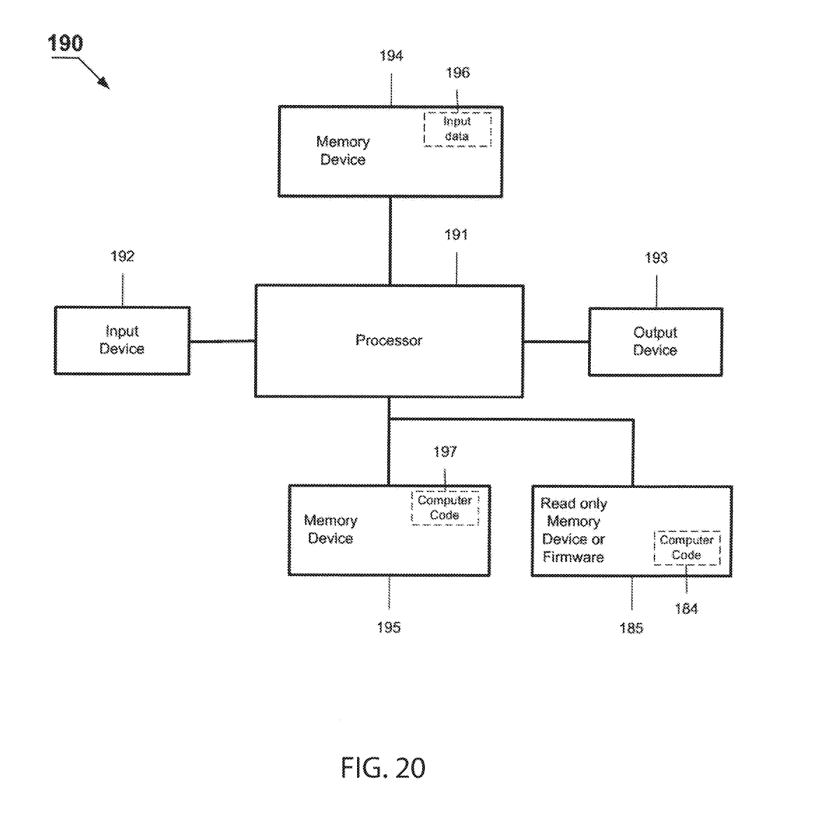

FIG. 20 illustrates a computer system 190 for enabling a method of determining an appropriate gift, in accordance with embodiments of the present invention.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 190 illustrated in FIG. 20 includes a processor 191, an input device 192 coupled to the processor 191, an output device 193 coupled to the processor 191, and memory devices 194 and 195 each coupled to the processor 191. The input device 192 may be, inter alia, a keyboard, a mouse, a camera, a touchscreen, etc. The output device 193 may be, inter alia, a printer, a plotter, a computer screen, a magnetic tape, a removable hard disk, a floppy disk, etc. The memory devices 194 and 195 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 195 includes a computer code 197. The computer code 197 includes algorithms for enabling a method accessing a database of stored information provided from a social media account of a recipient, analyzing the accessed information, and determining an appropriate gift to provide using the accessed information. The processor 191 executes the computer code 197. The memory device 194 includes input data 196. The input data 196 includes input required by the computer code 197. The output device 193 displays output from the computer code 197. Either or both memory devices 194 and 195 (or one or more additional memory devices such as read only memory device 196) may be used as a computer usable medium (or a computer readable medium or a program storage device) having a computer readable program code embodied therein and/or having other data stored therein, wherein the computer readable program code includes the computer code 197. Generally, a computer program product (or, alternatively, an article of manufacture) of the computer system 190 may include the computer usable medium (or the program storage device).

In some embodiments, rather than being stored and accessed from a hard drive, optical disc or other writeable, rewriteable, or removable hardware memory device 195, stored computer program code 184 may be stored on a static, nonremovable, read-only storage medium such as a Read-Only Memory (ROM) device 185, or may be accessed by processor 191 directly from such a static, nonremovable, read-only medium 185. Similarly, in some embodiments, stored computer program code 184 may be stored as computer-readable firmware 185, or may be accessed by processor 191 directly from such firmware 185, rather than from a more dynamic or removable hardware data-storage device 195, such as a hard drive or optical disc.

Still yet, any of the components of the present invention could be created, integrated, hosted, maintained, deployed, managed, serviced, etc. by a service supplier who offers to enable a method of gift giving and/or the other methods described herein. Thus the present invention discloses a process for deploying, creating, integrating, hosting, maintaining, and/or integrating computing infrastructure, including integrating computer-readable code into the computer system 190, wherein the code in combination with the computer system 190 is capable of performing a method of gift giving and/or other methods described herein. In another embodiment, the invention provides a business method that performs the process steps of the invention on a subscription, advertising, and/or fee basis. That is, a service supplier could offer to enable a method of gift giving or other method described herein. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 20 shows the computer system 190 as a particular configuration of hardware and software, any configuration of hardware and software, as would be known to a person of ordinary skill in the art, may be utilized for the purposes stated supra in conjunction with the particular computer system 190 of FIG. 20. For example, the memory devices 194 and 195 may be portions of a single memory device rather than separate memory devices.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of gift-giving comprising:
hosting, by a server, an account at least one of created and managed by an individual;
accessing, by the server, a database storing information provided from a social media account of a recipient after the individual becomes deceased;
analyzing, by the server, the information accessed by the server from the database; and
determining, by the server after the individual becomes deceased, an appropriate gift to provide the recipient using the information accessed by the server from the database.

2. The method of claim 1, further comprising purchasing, by the server, the appropriate gift and initiating providing, by the server, the appropriate gift to the recipient.

3. The method of claim 1, further comprising suggesting, by the server, the appropriate gift to an administrator of the account.

4. The method of claim 1, wherein the accessing and the analyzing are performed after the individual becomes deceased.

5. The method of claim 4, wherein the information received from the database includes information that was provided to the database after the individual becomes deceased.

6. The method of claim 1, wherein the determining further takes into account information provided by the individual before the individual becomes deceased.

7. The method of claim 6, wherein the information provided by the individual before the individual becomes deceased includes limitations selected by the individual, and wherein the limitations are associated with the account.

8. The method of claim 1, further comprising determining, by the server, an appropriate time to send the appropriate gift to the recipient using the information from the database.

9. The method of claim 1, further comprising obtaining permission, by the server from the recipient, to perform the accessing of the database, wherein permission is obtained from the social media account of the recipient.

10. The method of claim 1, further comprising accessing, by the server, a second database storing information provided from a second social media account of a non-recipient after the individual becomes deceased;
analyzing, by the server, the information accessed by the server from the second database;
determining, by the server after the individual becomes deceased, an appropriate gift to provide the recipient using the information accessed by the server from the second database.

11. A system comprising:
a server hosting an account that is at least one of created and managed by an individual; and
a database storing information provided from a social media account of a recipient after the individual becomes deceased;
wherein the server is configured to access the database after the individual becomes deceased;
wherein the server is configured to analyze the information accessed by the server from the database after the individual becomes deceased;
wherein the server is configured to determine, after the individual becomes deceased, an appropriate gift to provide the recipient using the information accessed by the server from the database.

12. The system of claim 11, wherein the server is configured to purchase the appropriate gift and provide the appropriate gift to the recipient.

13. The system of claim 11, wherein the server is configured to suggest the appropriate gift to an administrator of the account.

14. The system of claim 11, wherein the information received from the database includes information that was provided to the database after the individual becomes deceased.

15. The system of claim 11, wherein the server is configured to determine the appropriate gift taking into account information provided by the individual before the individual becomes deceased.

16. The system of claim 15, wherein the information provided by the individual before the individual becomes deceased includes limitations selected by the individual, and wherein the limitations are associated with the account.

17. The system of claim 11, wherein the server is further configured to determine an appropriate time to send the appropriate gift to the recipient using the information from the database.

18. The system of claim 11, wherein the server is configured to obtain permission to access the database, wherein permission is obtained from the social media account of the recipient.

19. The system of claim 11, further comprising a second database storing information provided from a second social media account, and wherein the server is configured to access the second database storing information provided from the second social media account of a non-recipient after the individual becomes deceased, wherein the server is configured to analyze the information accessed by the server from the second database, and wherein the server is configured to determine an appropriate gift to provide the recipient using the information accessed by the server from the second database.

20. A computer program product, comprising a computer readable hardware storage device storing a computer readable program code, said computer readable program code comprising an algorithm that, when executed by a server connected to a database, implements a method of gift-giving comprising:
hosting, by the server, an account at least one of created and managed by an individual;
accessing, by the server, the database, wherein the database stores information provided from a social media account of a recipient after the individual becomes deceased;
analyzing, by the server, the information accessed by the server from the database; and
determining, by the server after the individual becomes deceased, an appropriate gift to provide the recipient using the information accessed by the server from the database.
